(19) United States
(12) Patent Application Publication
(10) Pub. No.: US 2008/0208667 A1
(43) Pub. Date: Aug. 28, 2008

(54) Method for multi-sourcing technology based services

(76) Inventors: Gregg Lymbery, Wellington (NZ); Peter Cook, Wellington (NZ)

Correspondence Address: UNISYS CORPORATION, UNISYS WAY, MAIL STATION: E8-114, BLUE BELL, PA, 19424, US

(21) Appl. No.: 11/897,470

(22) Filed: Aug. 30, 2007

(30) Foreign Application Priority Data
Feb. 26, 2007 (NZ) 553471

(51) Int. Cl. G06F 9/46

(52) U.S. Cl. 705/8

(57) ABSTRACT

A computer implemented method of assigning responsibility for multi-sourced technology based services, the method including the steps of: defining a plurality of service delivery functions, defining collections of services that are to be provided by several service providers, providing metrics associating the service delivery functions with the collections of services, and inserting the metrics into a model to indicate which service providers are assigned responsibility for the service delivery functions.

This application claims priority from New Zealand provisional application No. 553471 filed on Feb. 26, 2007 and non-provisional application No. 553471 filed on Aug. 9, 2007 entitled “A Method for Multi-Sourcing Technology Based Services.”

The applicant's prior application “A Method for Outsourcing Technology Services” (Lymbery et al.), US2006/025685, the disclosure of which is incorporated by reference, discloses a method for outsourcing technology services.

The applicant's prior application “A System for Assisting the Generation of an Agreement for Outsourcing Technology Services” (Lymbery et al.), US2006/025678, the disclosure of which is incorporated by reference, discloses a system for assisting the generation of an agreement for outsourcing technology services.

The applicant's prior application “A System for Outsourcing Technology Services” (Lymbery et al.), US2006/025677, the disclosure of which is incorporated by reference, discloses a system for outsourcing technology services.

The applicant's prior application “A Method for Facilitating the Outsourcing of Technology Services” (Lymbery et al.), US2006/025686, the disclosure of which is incorporated by reference, discloses a method for facilitating the outsourcing of technology services.

### FIELD OF THE INVENTION

The present invention relates to a method of multi-sourcing technology based services. In particular, the present invention relates to a computer implemented method of negotiating and providing multi-sourced technology based services.

### BACKGROUND

In this application, the term multi-sourcing is generally defined as the provision of three or more service providers to provide a plurality of services.

Earlier patent applications by the applicant relate to the outsourcing of technology based services. These applications dealt with providing a mechanism for defining how technology based services are outsourced by an organisation (client) across a client environment. The present application addresses the particular problems associated with the multi-sourcing of technology based services.

In current solutions for multi-sourcing technology based services, problems can occur when defining which services or processes are allocated to a respective service provider. For example, it may not be clear which service provider is responsible for providing which service or process, or indeed if a particular service or process that is required has yet been allocated to a service provider. As the number of service providers increases, the problem is exacerbated. Further, with an increase in the number of services and processes being provided in a multi-sourced environment, a certain amount of duplication of allocation of activities associated with that service or process can occur. This can result in the inefficient use of resources.

During contract negotiations between an organisation and multi-sourced technology based service providers, metrics associated with specific tasks or procedures required to implement the processes or services are discussed and, negotiated. These metrics are aligned with a particular process or service associated with a particular service provider. That is, for each service provider, a metric is determined for carrying out the particular process or service. The organisation also determines a preferred total metric value associated with that process or service as provided by all service providers.

For example, one process may be the resolution of a problem notified to a support desk. Each of 4 service providers may indicate that, in order to carry out activities associated with that process, they can resolve the issue in 20 minutes. This results in a total resolution time of 80 minutes, i.e. 4×20 minutes. However, the organisation may wish the resolution of the problem to be carried out in less than 60 minutes.

As the number of service providers associated with the processes or services increases, it becomes more difficult to track, monitor and modify the associated metrics for all processes and services for all service providers whilst trying to ensure that the preferred total metric associated with each process or service is maintained. During the negotiation stage it also becomes increasingly difficult to determine any changes that may be required to the preferred total metric in order to fit in with the service to be provided or process to be implemented by the service providers that have been allocated.

After negotiations are complete and the services and processes of an organisation have been allocated within a multi-sourced service provider environment, monitoring of the performance or quality of the services and processes provided usually occurs at set time intervals of, for example, 6 months or 12 months. However, this can result in increased inefficiencies whereby the operation of certain services or processes changes over time and is allowed to continue outside of the defined metric between monitoring points. This could result in the inefficient operation of certain services or processes for extensive periods of time, such as, for example, up to 5 or 11 months between monitoring points.

For an event driven function, when allocating specific activities of a process to different service providers in a multi-sourced environment, unforeseen gaps can appear in the delivery of the complete process. For example, one activity forming the process may be the solving of a server problem. However, when each service provider carries out their associated activities for that process, there may be an inconsistency between when one service provider completes their particular activity, e.g. the procurement department purchasing a new server, and when another service provider starts their particular activity, e.g. the IT department installing the new server. One such inconsistency in this example could be that it was not clearly defined who was responsible for delivering the new server to the relevant site prior to installation.

Further, within a multi-sourcing environment, specific procedures or tasks may be defined in order to identify how a service provider provides a service or process that allows an organisation to either carry out its everyday business or to respond to certain events that occur during the operation of the organisation. Although it is known to define a list of specific tasks that describe how to carry out specific procedures or tasks forming the processes or services, these procedures or tasks are merely descriptive and so do not define in a tightly constrained manner how to carry out the procedure or task. The descriptive definitions provide too much flexibility when different service providers carry out the procedures or tasks, which can result in different outcomes for different service providers. Further, too much flexibility is provided when a change in service provider is made for a specific process or service. Further, the procedures or tasks being implemented by the service providers may not align with industry ‘best practice’ which the organisation wishes to adhere to.

Once negotiations between multi-sourced service providers and an organisation are complete, current systems do not allow a simple mechanism of measuring service performance levels for a specific service or process provided by numerous service providers. Therefore, the organisation that has multi-sourced multiple distinct collections of services associated with the services or processes is not able to easily determine if a required performance level is being achieved by all service providers or indeed if each individual service provider is performing at the correct negotiated level. That is, there is no simple mechanism for providing an up to date output of the performance level provided by each service provider for a particular service or process, nor is there a simple mechanism of providing an output of the up to date performance level of the service or process related to a specific technology element as provided by all associated service providers. Further, if the current performance level of a multi-sourced service or process is not being achieved, current systems do not provide a mechanism for resolving issues associated with the underachieving service or process.

During the normal operation of an organisation in a multi-sourced environment, monitoring of the performance levels of specific services or processes, as provided by allocated service providers, is carried out by regular audits within the organisational structure. These audits are directed at ensuring that the organisation and service providers are operating in alignment with an industry ‘best practice’. However, it can be time consuming for an organisation to gather and analyse the various performance factors in a multi-sourced environment due to the increased number of service providers providing the numerous services or participating in the requisite processes.

In a multi-sourced environment, organisations require certain processes to be carried out when an event occurs that affects the provision of a collection of services. That is, certain events can occur that are outside of the normal everyday running of the organisation. These events require specific tasks to be carried out in order to resolve any associated problems. It is usual for an organisation to have certain mechanisms in place, for example, at a support desk, whereby the reporting of events is handled in a certain manner. However, these mechanisms can result in an inefficient method of resolving the event and can result in the managing of similar or the same events in different ways.

For example, one operator at a support desk receiving the report of a specific event, such as the failure of an e-mail delivery system, may decide to resolve the failure by logging a fault identifying the failure of an e-mail server based on the information received. Whereas, a second operator may have determined a different problem associated with the event and instigated the investigation of the configuration of a user's personal computer within an office of the organisation. These inconsistencies can result in problems associated with the event not being resolved in a time efficient manner.

In current negotiation environments, a suitable multi-sourcing agreement is produced between multi-sourced service providers and an organisation. However, there can be a distinct lack of collaboration between the different levels of governance of the organisation when determining how the different processes, services and roles are to be allocated. That is, although the operational level of the organisation may be directly involved with the negotiation of services and processes including their required performance levels, the upper levels of the organisation, such as the tactical and strategic levels, are not so easily placed to provide input at the negotiation stage, nor are they easily placed to receive feedback from the operational level on the current status of negotiations. Therefore, when certain processes or services are defined or changed during the negotiations at the operational level, these may not comply with what is required at other levels of the organisation. Further, when certain roles are changed at tactical or strategic levels these changes may not be implemented at an operational level. This may result in having to renegotiate the multi-sourcing agreement causing unnecessary delays and an increase in costs.

The present invention aims to overcome, or at least alleviate, some or all of the afore-mentioned problems.

### SUMMARY OF THE INVENTION

In the present invention a method is disclosed for identifying which service providers are allocated responsibility for event driven and business as usual functions. The identification is provided by using a model to indicate the allocation of processes or services forming the event driven and business as usual functions. The model may indicate in a series of horizontal rows the processes and services being supplied, while organisation specified or specific collections of services provided by the service providers may be indicated in the model in a series of vertical columns. Further, a method is disclosed for linking a service provider's activities for event driven functions together to ensure a gap does not exist when providing the process. Also, a method is disclosed for generating procedures for sub-activities of the processes in event driven functions to ensure that each process is carried out in a uniform manner. In addition, a method is disclosed for indicating current and target service performance levels for processes and/or services, as well as a method of providing access to performance metrics to third parties. Further, a method is disclosed for providing a rules engine to output information required to resolve an event. Also, a method is disclosed for defining roles, functions and responsibilities in a governance model in order to ensure full collaboration between different levels of governance and associated services, processes, roles and service providers.

In one aspect, the present invention provides a computer implemented method of assigning responsibility for multi-sourced technology based services, the method including the steps of: defining a plurality of service delivery functions, defining collections of services that are to be provided by several service providers, providing metrics associating the service delivery functions with the collections of services, and inserting the metrics into a model to indicate which service providers are assigned responsibility for the service delivery functions.

In a further aspect, the present invention provides a computer implemented method of defining service delivery functions linking collections of services in a multi-sourced technology based service environment, the method including the steps of: defining collections of services that are to be provided by several service providers, defining a plurality of service delivery functions associated with the collections of services, defining process activities for executing the service delivery functions, defining sub-activities for implementing at least one of the process activities in relation to the collections of services, wherein at least two sub-activities have interdependent inputs and outputs.

In yet a further aspect, the present invention provides a computer implemented method of defining service delivery functions for multi-sourced technology based services, the method including the steps of: defining a plurality of service delivery functions, defining collections of services that are to be provided by several service providers, generating a plurality of activities for executing the service delivery functions, generating a plurality of sub-activities for at least one of the activities, and generating instructions to carry out at least one of the sub-activities, said instructions providing information associated with how to execute the sub-activity.

In yet a further aspect, the present invention provides a computer implemented method of providing a current service performance level and a target service performance level in a multi-sourced technology based service environment, the method including the steps of: defining a plurality of service delivery functions, defining collections of services that are to be provided by several service providers, defining a target service performance level for at least one of the service delivery functions, retrieving metrics associated with a current service performance level for an associated collection of services, determining a current service performance level for the service delivery function based on the retrieved metrics, and providing an output to indicate the current and target service performance levels.

In yet a further aspect, the present invention provides a computer implemented method for monitoring the performance of multi-sourced technology based services for a client, the method including the steps of: defining a plurality of service delivery functions, defining collections of services that are to be provided by several service providers, wherein the collections of services are associated with the service delivery functions and the service delivery functions are defined according to a common standard across all associated collections of services, calculating and storing performance metrics for the service delivery functions in association with the collections of services, and providing access to the stored performance metrics to a third party to allow monitoring of the performance of a service delivery function for at least one of the collections of services.

In yet a further aspect, the present invention provides a computer implemented method of allocating governance responsibilities in a multi-sourced technology based service environment, the method including the steps of: defining a plurality of service delivery functions, defining collections of services that are to be provided by several service providers, wherein the collections of services are associated with the service delivery functions, defining a rules engine that includes resolution information for resolving an event associated with at least one of the collections of services, receiving information associated with the event, providing the event information to the rules engine, processing the event information in the rules engine, and outputting resolution information associated with the event from the rules engine.

In yet a further aspect, the present invention provides a computer implemented method for defining the requisite roles, functions or responsibilities in a multi-sourced technology based service environment, the method including the steps of: defining a governance model by defining an operational level of governance and at least one further level of governance for the model, defining the operational level of governance by: defining a plurality of service delivery functions which include services and processes, and defining collections of services provided by several service providers, wherein the collections of services are associated with the service delivery functions, defining levels of governance by defining a plurality of roles for controlling the provision of the service delivery functions, changing a process, service or role, and adapting the governance model based on the changed process, service or role to ensure collaboration between the governance levels.

### BRIEF DESCRIPTION OF THE DRAWINGS

Embodiments of the present invention will now be described, by way of example only, with reference to the accompanying drawings, in which:

FIG. 1 shows the concept of multi-sourcing technology based services;

FIG. 2 shows the negotiation process when multi-sourcing technology based services;

FIG. 3 shows an operational governance model for use in negotiating the sourcing of multi-sourced services according to an embodiment of the present invention;

FIG. 4 shows a computer system adapted to provide the model as shown in FIG. 3 according to an embodiment of the present invention;

FIG. 5A shows details of the operational governance model according to an embodiment of the present invention;

FIG. 5B shows details of a JRM Builder tool;

FIG. 5C shows details of a responsibility matrix;

FIG. 5D shows details of Incident Management activities for use according to an embodiment of the present invention;

FIG. 5E shows details of Systems Administration activities for use according to an embodiment of the present invention;

FIG. 5F shows details of a CobiT aligned metric for use according to an embodiment of the present invention;

FIG. 5G shows details of an ITIL process maturity measurement for use according to an embodiment of the present invention;

FIG. 5H shows an ARCI metric for use according to an embodiment of the present invention;

FIG. 5I shows an overall ITIL process maturity measurement for use according to an embodiment of the present invention;

FIG. 5J shows a CobiT maturity metric for use according to an embodiment of the present invention;

FIG. 5K shows an example of a process touch point according to an embodiment of the present invention.

FIG. 5L shows the documentation structure for the governance framework at different levels of governance.

FIG. 6A shows a diagrammatic representation of interdependent sub-processes according to an embodiment of the present invention;

FIG. 6B shows a flow diagram for linking interdependent inputs and outputs of sub-processes according to an embodiment of the present invention;

FIG. 7A shows a diagrammatic representation of a task list created for a process according to an embodiment of the present invention;

FIG. 7B shows a flow diagram for creating a task list according to an embodiment of the present invention;

FIG. 8A shows the flow of information for providing current and target performance levels according to an embodiment of the present invention;

FIG. 8B shows a pictorial representation of the determination of the current performance level from the model according to an embodiment of the present invention;

FIG. 8C shows a flow diagram for providing information on how to achieve a target performance level according to an embodiment of the present invention;

FIG. 9A shows the flow of information for allowing a third party to access performance data according to an embodiment of the present invention;

FIG. 9B shows a flow diagram for allowing a third party to access performance data according to an embodiment of the present invention;

FIGS. 10A and 10B show flow diagrams of an event resolution procedure according to an embodiment of the present invention;

FIG. 11 shows the flow of information for resolving an event according to an embodiment of the present invention;

FIG. 12 shows a model for governing a multi-source environment according to an embodiment of the present invention;

FIG. 13 shows the flow of information for the model shown in FIG. 12 according to an embodiment of the present invention;

FIG. 14 shows a flow diagram for collaboration between different levels of a multi-sourcing governance model according to an embodiment of the present invention;

### GLOSSARY OF RELEVANT TERMS

Service Provider: One of multiple entities that are envisaged to provide a technology based service.

Organisation (Client to the service providers): The entity that is negotiating with or designating multiple service providers to supply technology based services.

Technology Based Services: A service or process that is to be supplied by a service provider using elements of technology.

Performance Level: A measurable level of how a process or service is performing.

Support Desk (Desk Services): A single integrated point of contact for interaction with an organisation.

Service Delivery Functions: A process or service enabling an organisation to carry out event driven and business as usual functions.

Event Driven Functions: Processes that enable an organisation to handle an event that occurs outside of normal business activities.

Business as Usual Functions: Services that enable an organisation to operate everyday normal business activities.

Process: A defined set of activities and procedures to enable an organisation to handle an event that occurs outside of normal business activities.

Service: A defined set of activities and tasks to enable an organisation to handle functions associated with normal business activities.

Collection(s) of services: A specified grouping of technology based services.

Task List: A defined course of action for carrying out a sub-activity of a service.

Procedure: A defined course of action for carrying out a sub-activity of a process.

Process activity: A course of action required to implement a process.

Service activity: A course of action required to provide a service.

Sub-activity: A subset of a process activity or a service activity resulting in either procedures or task lists.

Rules Engine: A logical module that provides a set of rules based on received input.

Current service performance level: A measurement of the current level of performance by a service provider for a particular technology based service.

Target service performance level: A negotiated level of performance that an organisation wishes a service provider to achieve for a particular technology based service.

Matrix: A framework of rows and columns for identifying which services and processes are associated with collections of services as provided by service providers.

Responsibility matrix: A framework of rows and columns for identifying which service providers are responsible for providing services to an organisation.

JRM Builder Tool: Joint Responsibility Matrix Builder Tool; a tool devised by the applicants to enable an organisation to allocate responsibility of services to more than one service provider.

Interaction Charter: A set of operating principles defined at a tactical level including the rules of interaction between service providers and the organisation.

Memorandum of Understanding: A set of guiding principles defined at a strategic level including definitions of the roles, functions and responsibilities of the organisation and how the performance of service providers is to be assessed by the organisation.

Level of Governance: An indication of the level in an organisation that is responsible for governing a process, service or role.

Operational Level: A level of governance in an organisation that is responsible for governing processes or services used to allow the organisation to operate effectively.

Tactical Level: A level of governance in an organisation that is responsible for the operational level of governance and is responsible for enabling the organisation to achieve a specific object or resolve a specific problem.

Strategic Level: A level of governance in an organisation that is responsible for the operational level and tactical level of governance and is responsible for overseeing and defining a long term action plan for the organisation.

CobiT: Control Objectives for Information and related Technology.

CobiT Maturity: A measurement of the level a service has been implemented.

ARCI: A metric to define the entity that is to be held Accountable, held Responsible, to be Consulted or to be Informed.

KPI: Key Performance Indicator.

KGI: Key Goal Indicator.

OGC: Office of Government Commerce.

SLA: Service level agreement; a definition of the terms that a service provider is to meet in order to provide a specific service.

ITIL: Information Technology Infrastructure Library; a framework of best practice to enable the efficient delivery of technology based services.

### DETAILED DESCRIPTION OF THE INVENTION

The present invention will be described in relation to the multi-sourcing of information technology based services. However, it will be appreciated that, the invention may also be adapted for use with the multi-sourcing of other technology based services.

In this application, the term multi-sourcing, or derivatives thereof, is intended to mean the sourcing of three or more service providers in order to provide two or more services to an organisation.

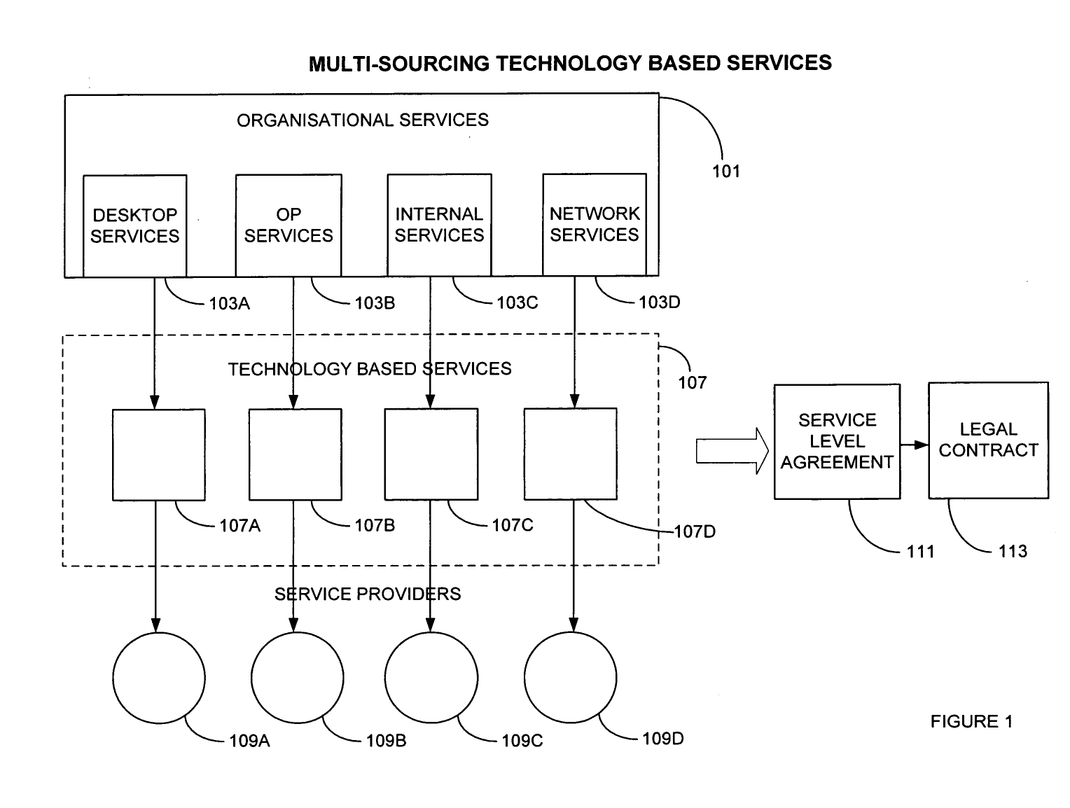

FIG. 1 shows the concept of multi-sourcing technology based services. An organisation (customer) 101 can have its environment defined as a number of distinct elements 103A-D that allow the organisation to operate. For example, the elements may consist of desktop services, operational services, internal services, network services, applications support etc. For each of these elements a collection of technology based services 107 is required to allow the organisation to operate effectively. The organisation may decide to multi-source a number of these technology based services to several service providers in order to provide a more streamlined operation. Further, the multi-sourcing of technology based services provides increased efficiencies due to the multi-sourced service providers being in a position to supply specialised technology based services at efficient production and cost rates. This also allows the organisation to concentrate on the core parts of its organisation.

The responsibility of providing the multi-sourced technology based services (107A-D) is given to a number of different service providers (109A-D). Information concerning how the technology based services are to be provided is incorporated in a Service Level Agreement (SLA) 111. This defines in a clear manner the expected quality level the service provider is to provide for the technology based services it is responsible for. The SLA 111 is then incorporated into a legal contract 113 to ensure that there is compliance with the agreement.

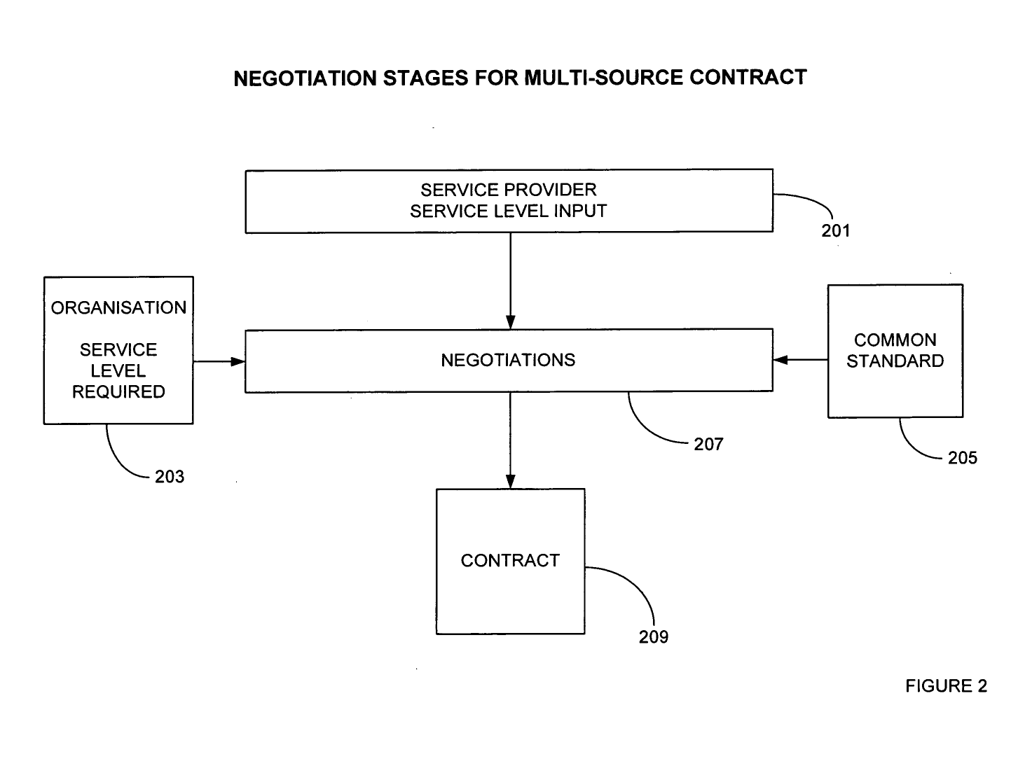

FIG. 2 shows the negotiation stages associated with creating a multi-sourcing contract. The service provider provides input 201 as to the level of service it can provide for a particular technology based service. The organisation also provides input 203 on the level of service it requires for the technology based service. Information concerning the use of a common standard 205 is also provided. All this information (201, 203, 205) is used during the negotiation stage 207. After negotiation, the contract 209 is produced. The contract can include, for example, the SLA, equipment schedules, statements of work etc.

The information from the organisation and service providers encompasses, for example, the services to be provided and processes to be implemented, the service performance levels, costs of providing the services and implementing the processes, and all other associated factors for the technology based services.

Information associated with a common standard 205 is used to ensure that the services being provided and processes being implemented align to a common standard. The common standard usually refers to the industry ‘best practice’ associated with the organisation. In this embodiment, the common standards referred to include ITIL (Information Technology Infrastructure Library) and CobiT (Control Objectives for Information and related Technology). It will be understood that other standards or mechanisms for defining different aspects of the technology based service provision may also be used to allow negotiations to conform to a set standard, such as, for example, e-SCM (e-sourcing Capability Model).

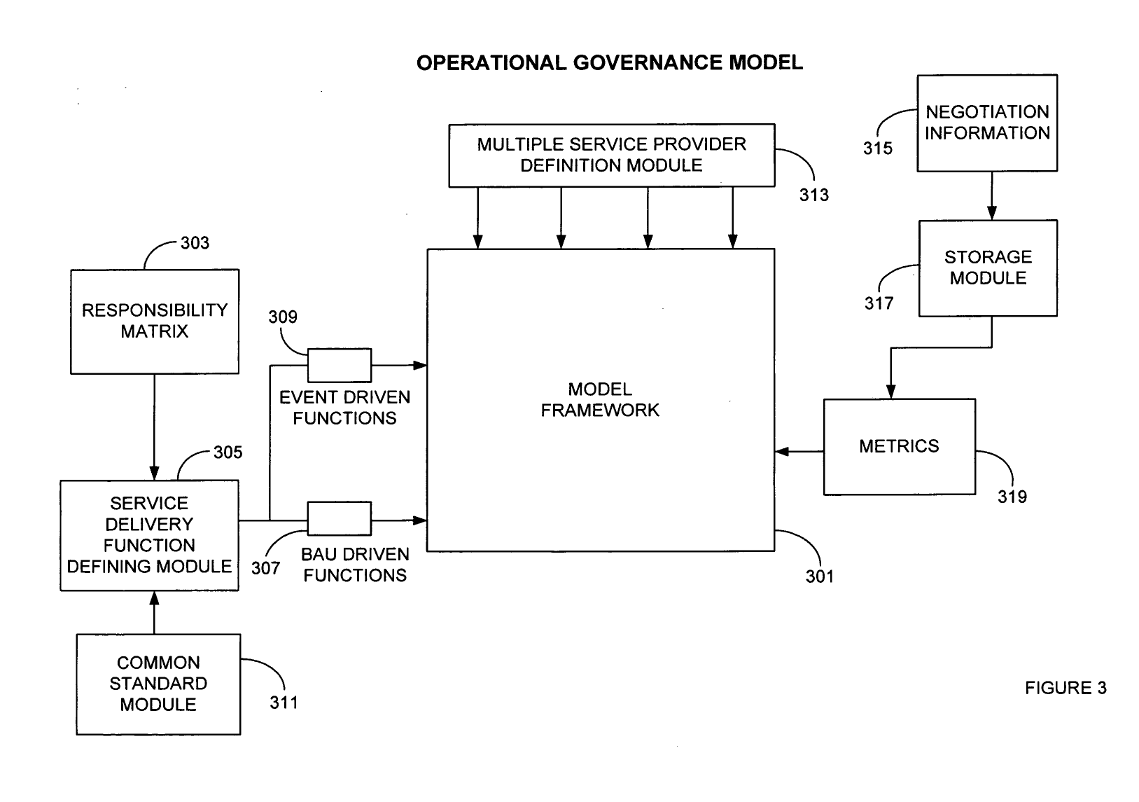

FIG. 3 shows an operational governance model for use in negotiating the sourcing of multi-sourced technology based services according to this embodiment. A framework 301 is provided to hold information concerning the provision of multiple technology based services by several service providers during the negotiation stage between an organisation and the service providers.

Information received from a responsibility matrix 303 forming part of a JRM (Joint Responsibility Matrix) Builder Tool is provided to aid the definition of technology based services being multi-sourced. The JRM tool was devised by the applicant for use in outsourcing technology based services and provides a mechanism for defining specific technology based services for outsourcing by an organisation (client) across a client environment.

Using the tool, a responsibility matrix 303 is produced to identify the responsible parties for providing certain technology based services within the organisation. The client environment is defined in order to provide a context in which the technology based services are to be provided across the organisational environment. That is, an organisation is defined in terms of the group of elements making up the organisation. This could be, for example, different operational departments within the organisation, different locations of offices of the organisation or different technology elements of the organisational environment. Any suitable definition may be used. In this manner it is possible to produce a matrix of responsibilities for certain processes and services in the organisation according to the defined groups of elements. The processes and services are defined in line with a common standard, such as ITIL.

One example of a responsibility matrix could show that the organisation environment is grouped into separate elements such as payroll systems, messaging systems, application systems etc. Further, service delivery functions are defined for each collection of technology based services. At each intersection in the matrix the party responsible for carrying out the services or processes for that part of the organisation is identified. Information from the responsibility matrix 303 is fed into a service delivery function defining module 305.

Information concerning the processes or services is provided by the service delivery defining module 305. This module outputs service delivery functions in the form of a list of defined technology based services that are to be multi-sourced and so placed within the operational governance model 301. The service delivery functions are separated into two distinct groups. A first group of service delivery functions is defined as being ‘business as usual’ (BAU) driven functions 307. These functions define a number of services associated with how the organisation operates during everyday normal business operations. A second group of service delivery functions is defined as being ‘event driven’ functions 309. These functions define a number of processes that a service provider is required to implement upon the occurrence of an event. An event driven function occurs when something happens that is outside of the normal business operation. Some non-limiting examples of event driven functions include the identification and reporting of a problem that has arisen within the organisation, the receipt of a request for change in a specific business practice, or the receipt of the decision to change various software or hardware elements of the organisation. The event driven functions are handled by a support desk as a single integrated point of contact and are defined as a number of processes enabling an organisation to react and control events outside of everyday business operations, as will be explained later.

The service delivery function defining module 305 is also aligned with one or more common standards using a common standard module 311. That is, the common standard module 311 provides information concerning any common standard that is used to align the service delivery functions with the common standard.

A multiple service provider definition module 313 provides details of the service providers involved in the multi-sourcing negotiations with the organisation. This information is placed in the operational governance model framework 301.

During negotiations between the service providers and the organisation, information 315 concerning the required technology based services is determined and stored in a storage module 317. Metrics 319 are extracted from the storage module 317 and are placed into the operational governance model framework 301. The metrics provide information about the defined service delivery functions in relation to the associated service provider. In its simplest form, the metrics may provide an indication as to whether or not the service provider is the provider of the service, for example, by inserting a tick mark or cross. Alternatively, the metrics may provide more detailed indications or measurements concerning the level of service expected to be provided by the service provider for the provision of the technology based service. It will be understood that the term metrics in this embodiment is intended to mean a measurement, which includes a measurement of whether or not a particular state exists. In this embodiment, the metrics used include CobiT, ITIL and an ARCI (Accountable, Responsible, Consulted and Informed) matrix, but it will be understood that other suitable metric measurements may be used. For example, the term metric includes output measures, outcome measures, service delivery process performance, service delivery process outcome and service delivery process maturity.

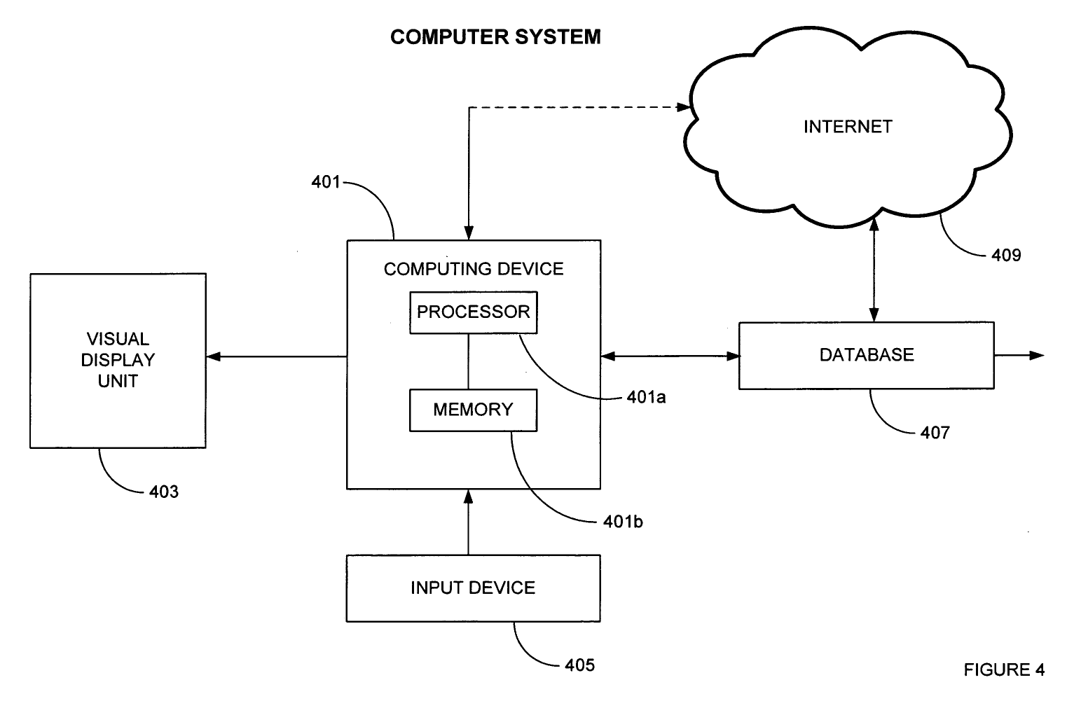

FIG. 4 shows a computer system adapted to implement the method described herein. A computing device 401, such as a personal computer for example, including a processor 401A and memory 401B is used. In this embodiment, the computing device has a visual display device 403 connected to it that is capable of displaying a graphical user interface. The graphical user interface displays as part of the general model the operational governance model. Further, an input device 405, such as a keyboard, is connected to the computing device.

Computer software suitable for implementing the method described herein may be stored on a suitable medium such as the computer memory 401B. The computing device may also be in communication with an external database 407 and/or other computing systems over a network, such as the Internet 409. It will be appreciated that the system can be developed using one of any number of programming languages and can be deployed within many different hardware configurations.

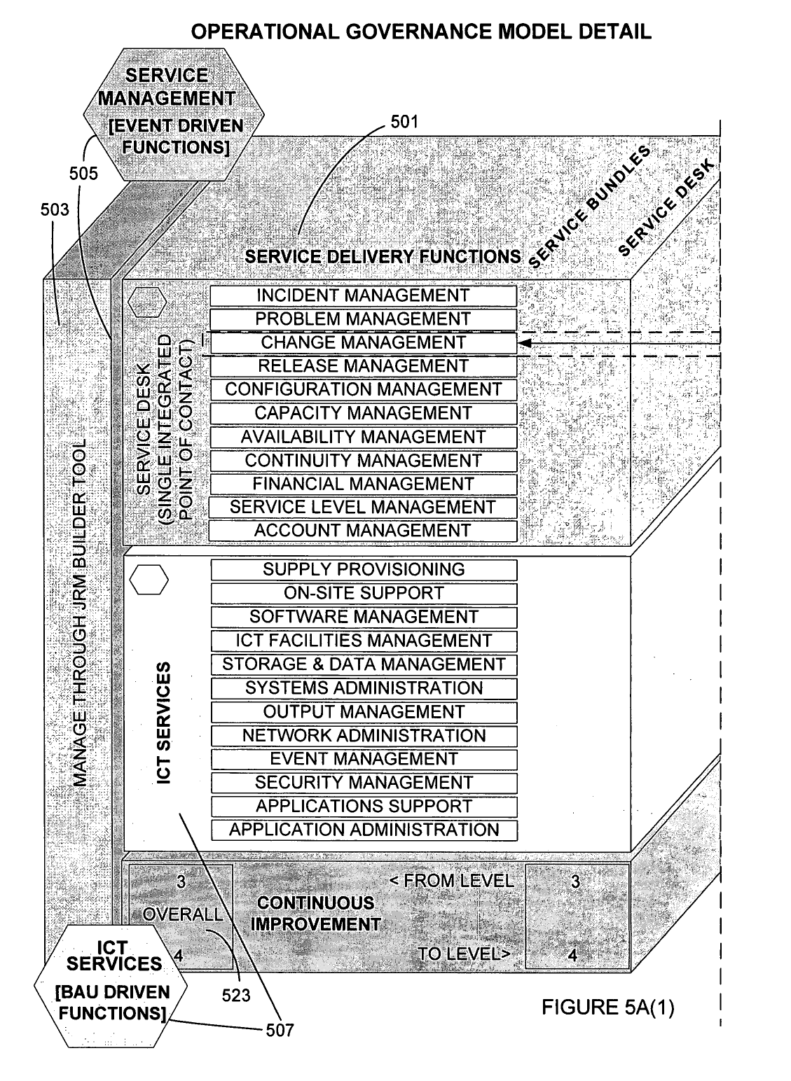

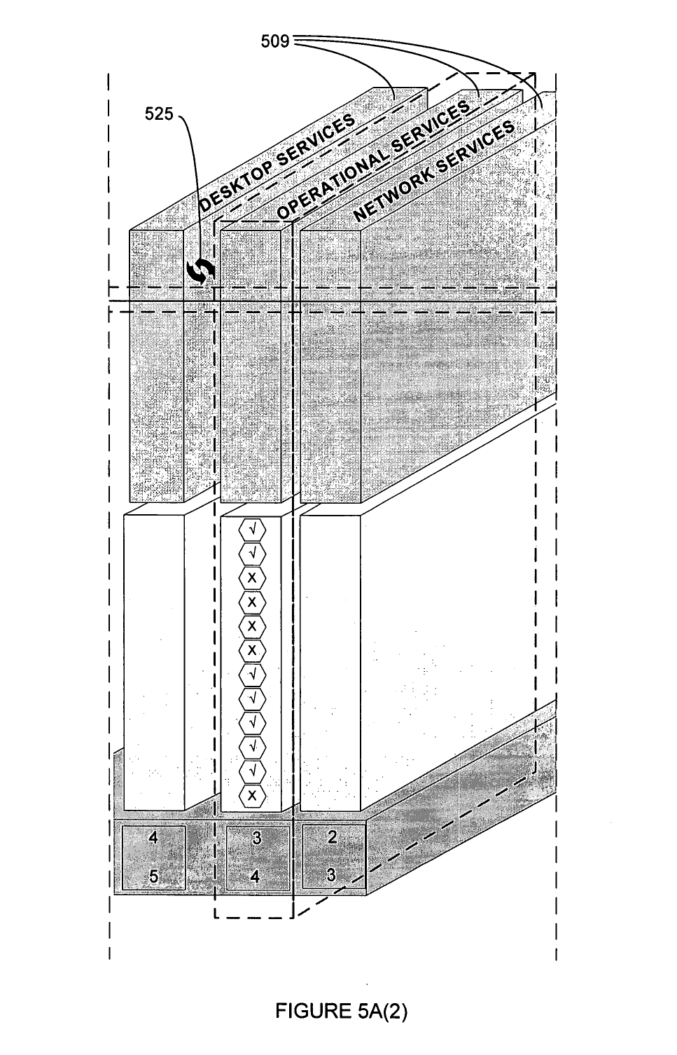

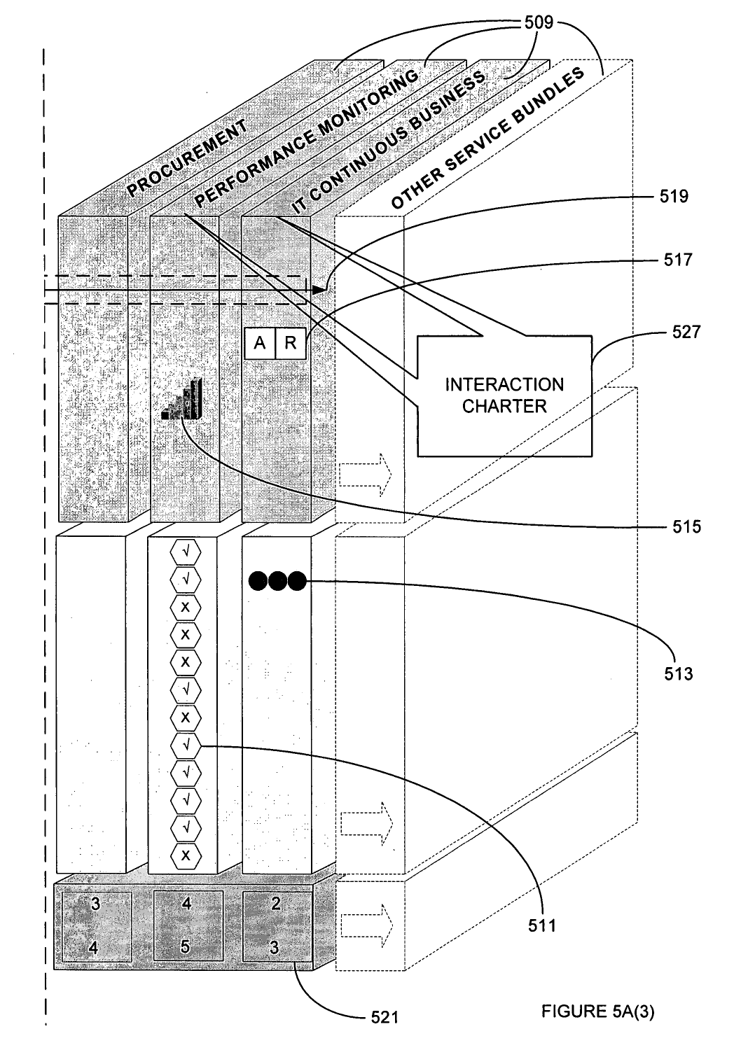

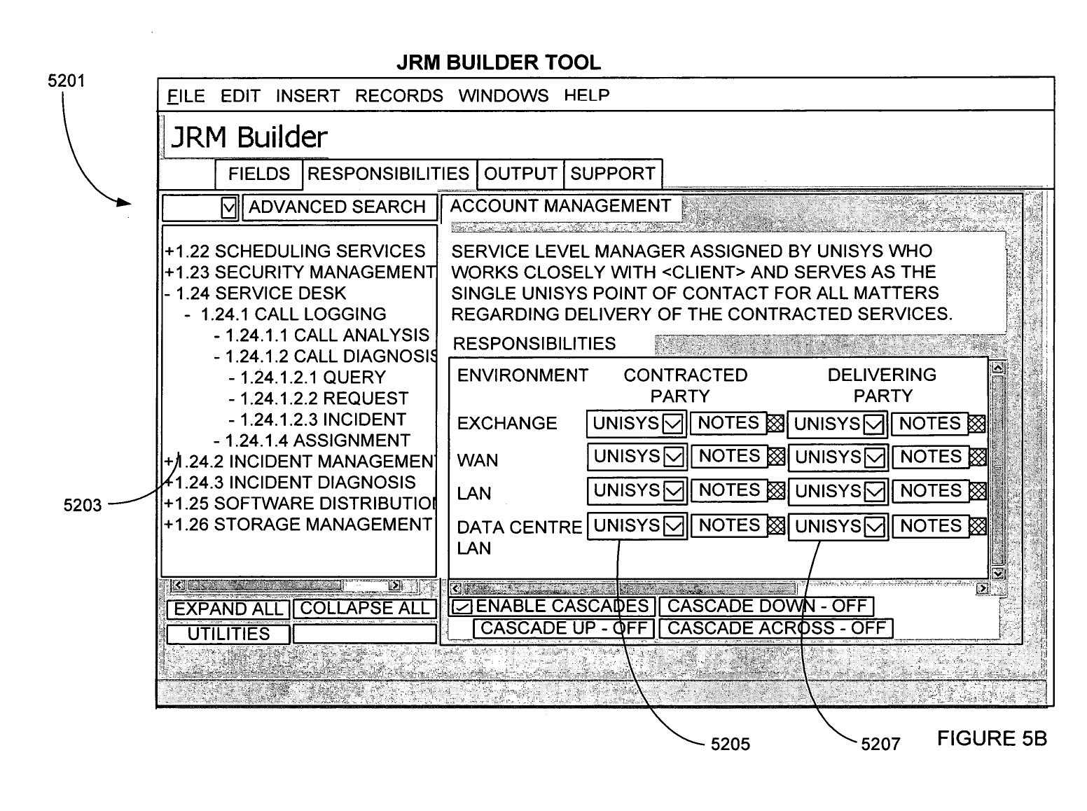

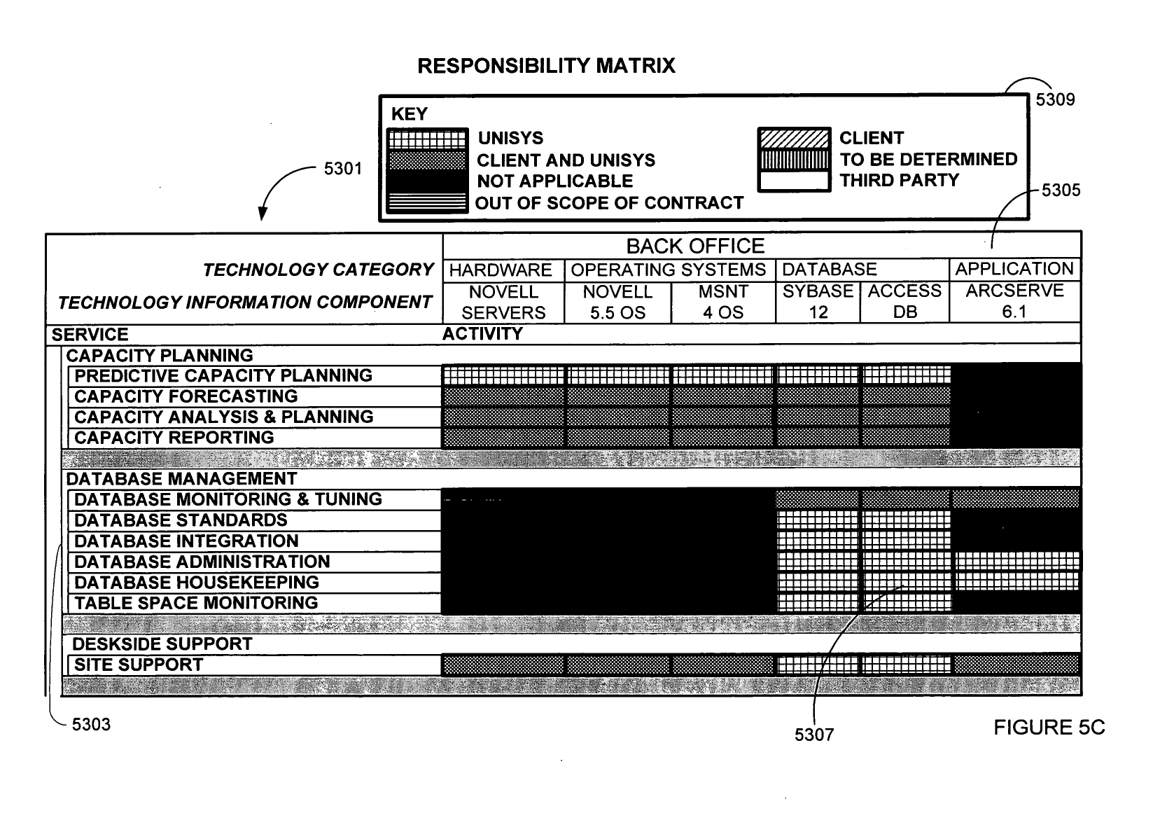

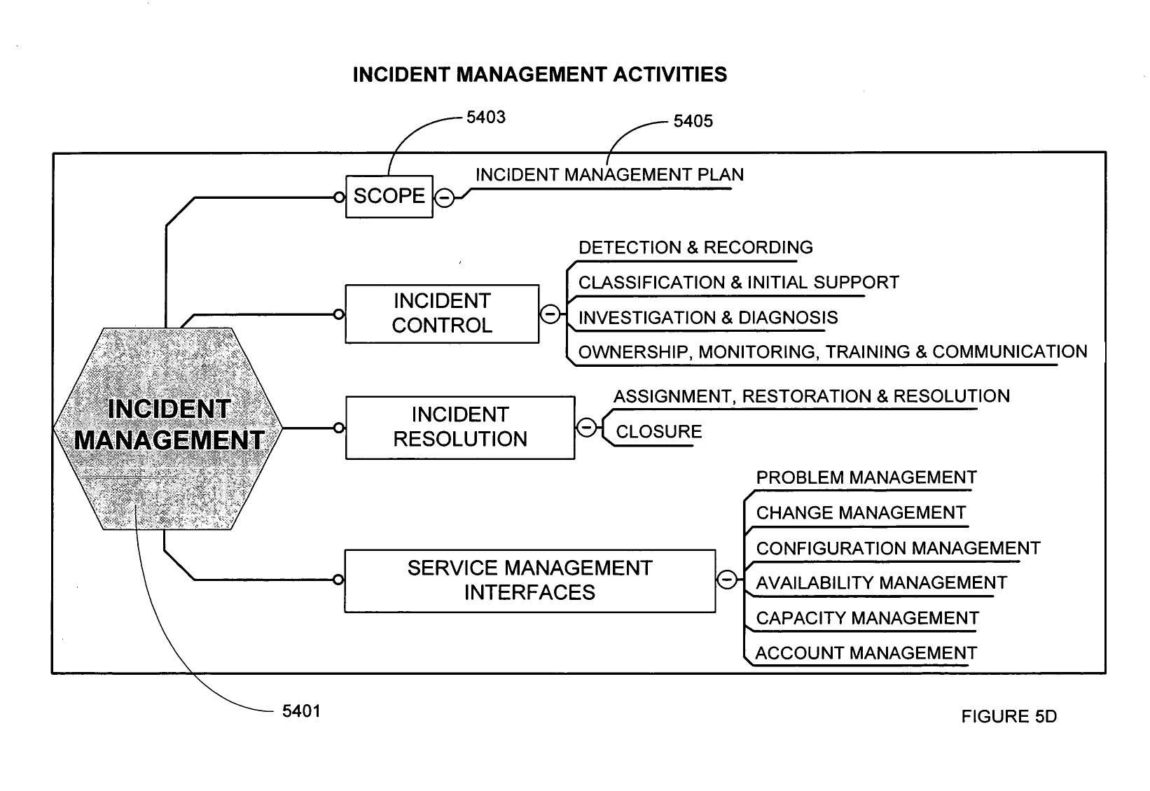

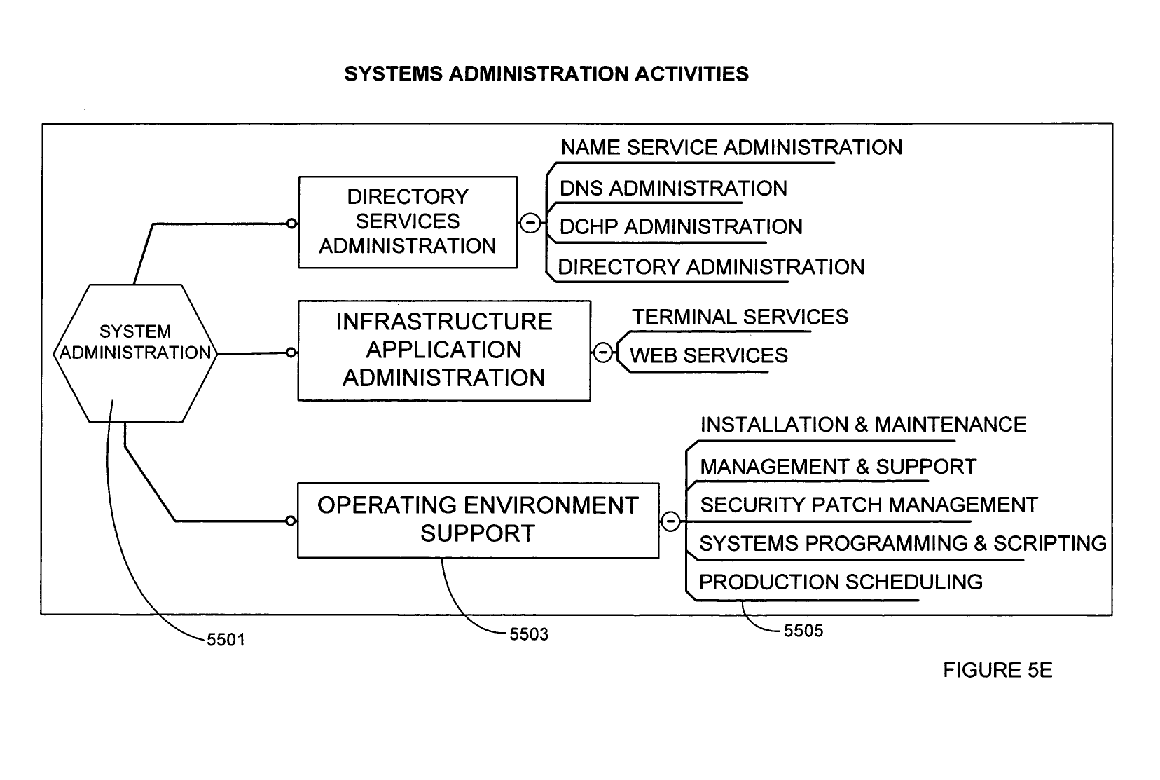

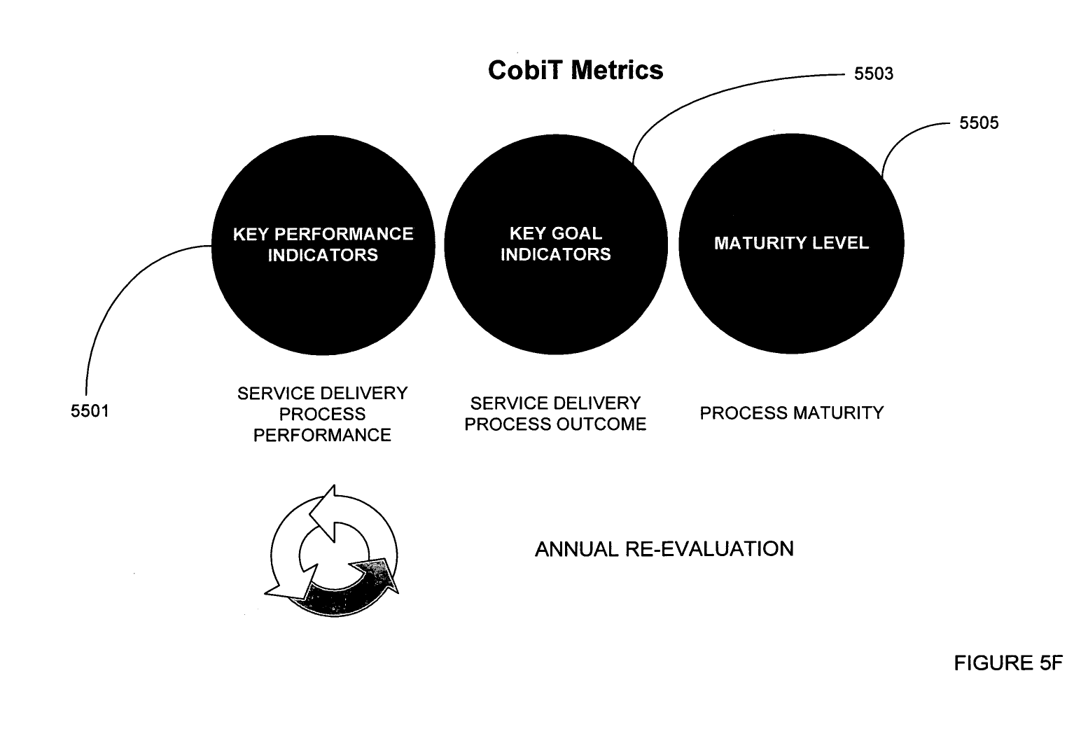

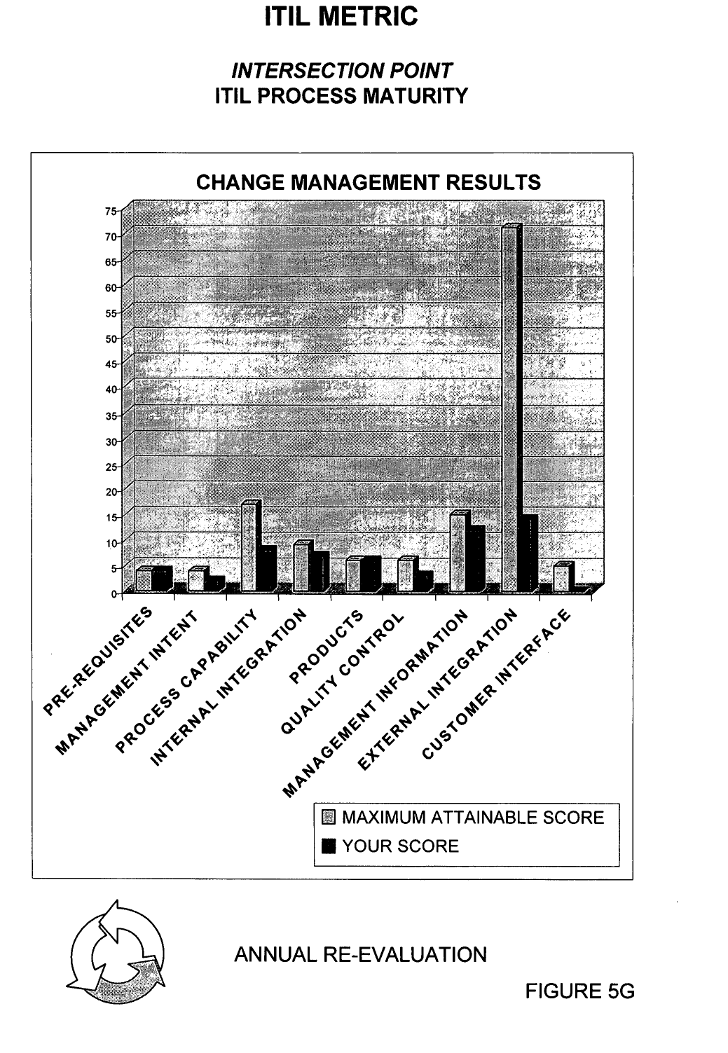

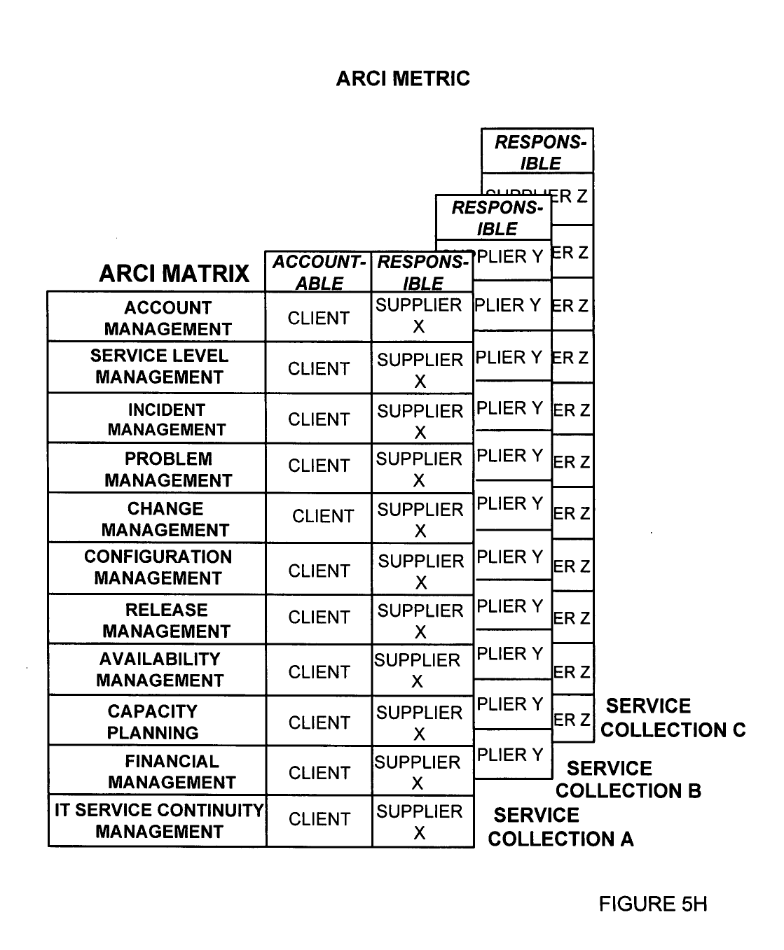

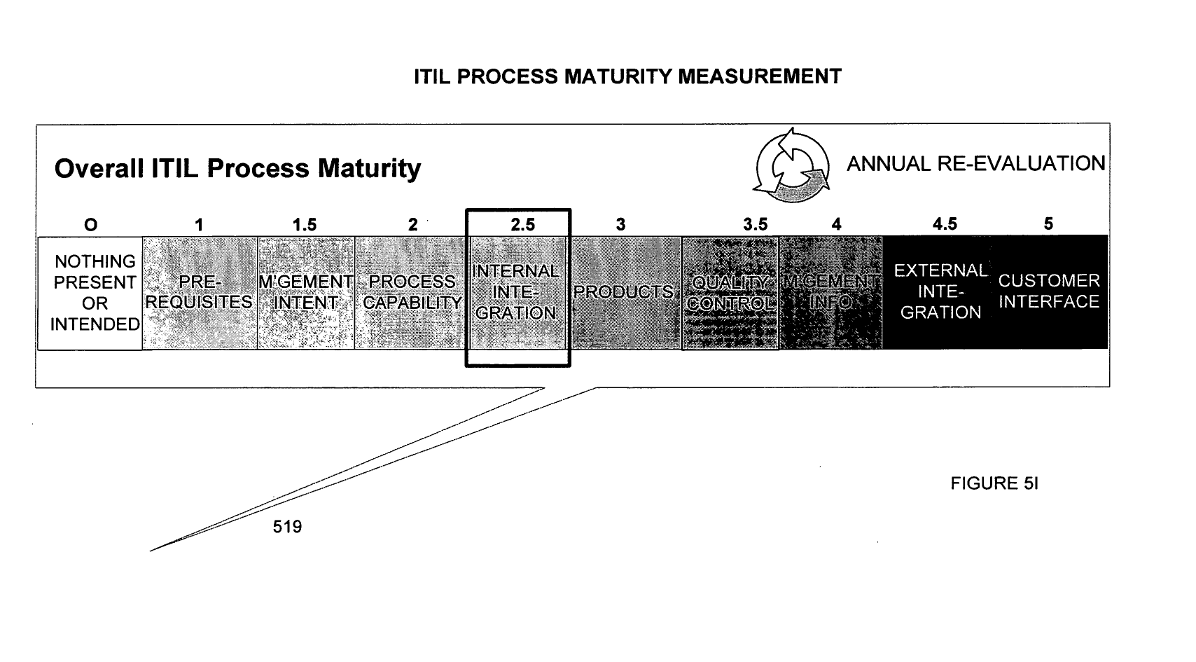

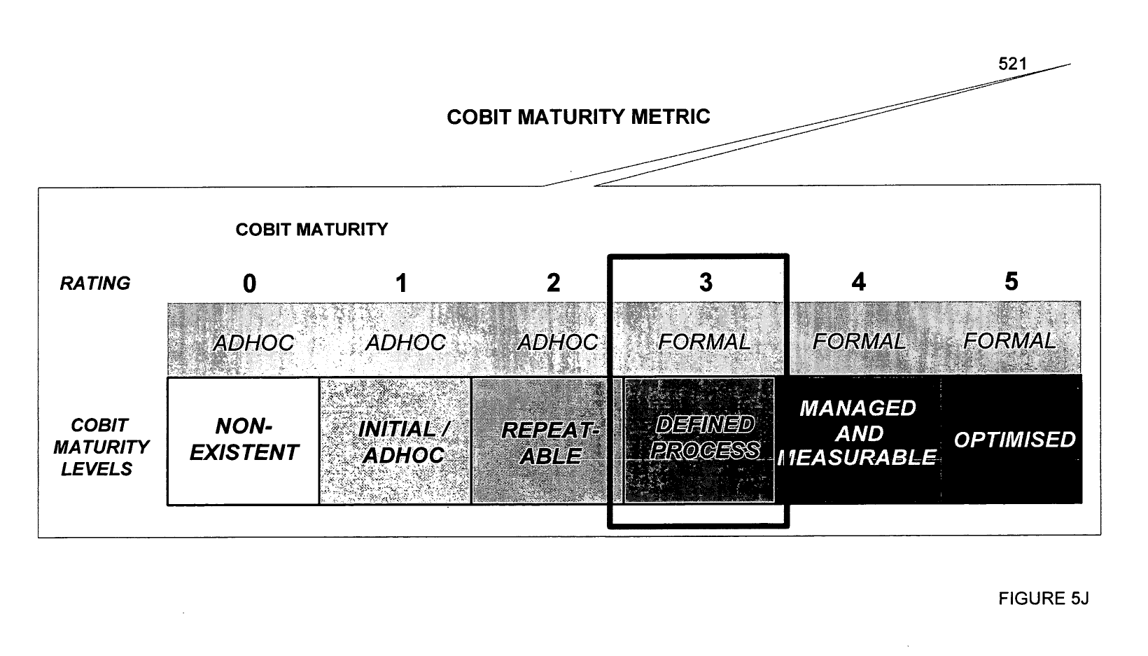

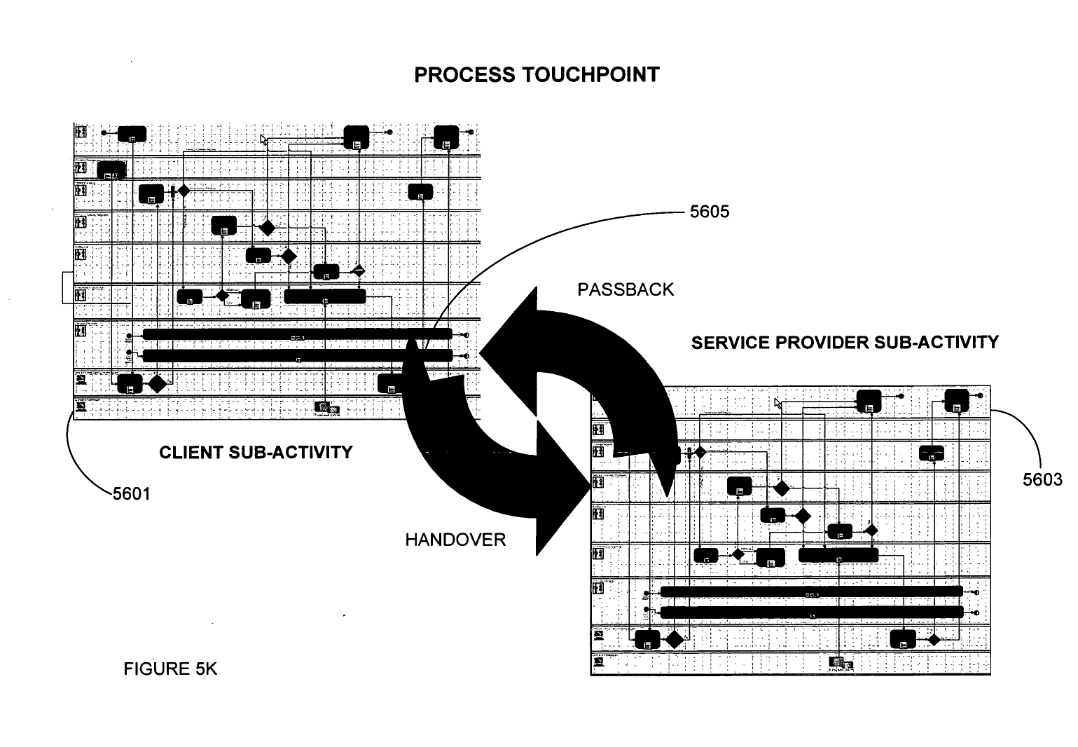

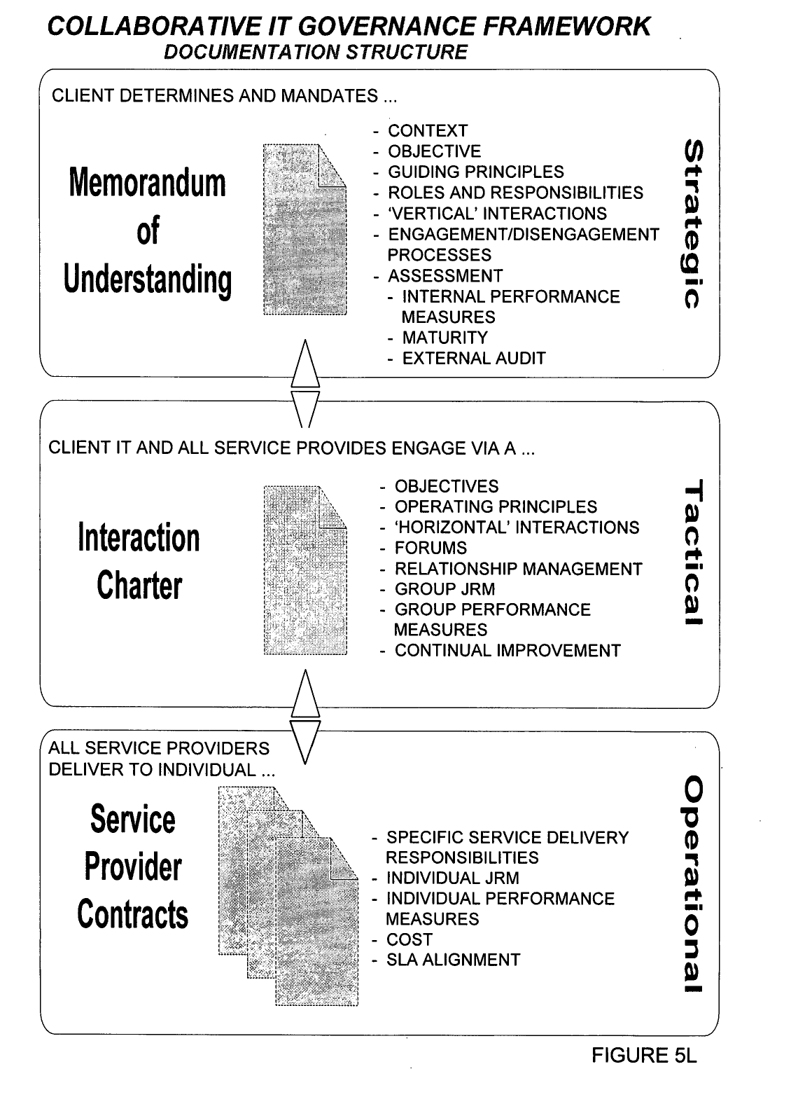

FIG. 5A shows a graphical representation of the operational governance model. This graphical representation is displayed on the visual display device of the computing system described above.

A column of service delivery functions 501 is shown in the model. The list is separated into the two groups of event driven functions (Service Management) 505 and business as usual (BAU) driven functions (Information and Communications Technology (ICT) services) 507, as explained above. The event driven functions are provided in the top half of the model, while the BAU driven functions are provided in the lower half of the model. The information associated with the service delivery functions is managed through the JRM builder tool 503 and Responsibility Matrices.

Other elements shown in the model of FIG. 5A will be explained in more detail below. These elements include metrics (511, 513, 515, 517), process flow 519, performance level measurements (521, 523), process touch points 525 and an Interaction Charter 527.

The Interaction Charter 527 is used in conjunction with the process touch points, and is used to ensure that common contract (i.e. collaboration or co-operation) and behaviour standards are maintained across all service providers, present and future. The Interaction Charter determines at a tactical level how different service providers operate with each other contractually in relation to the collection of services that they are responsible for. Further, the Interaction Charter also determines how an organisation interacts with the service providers in relation to their associated collections of services. The Interaction Charter is used in conjunction with a Memorandum of Understanding, at a strategic level, and Service Provider Agreements, at an operational level. An overall description of these elements is now provided with reference to FIG. 5L.

### Collaborative IT Governance Framework

As explained herein, the governance of all services stakeholders, both service providers and the organisation, is coordinated through an IT Governance Framework outlining the terms and details of an agreement between the parties, including each parties requirements and responsibilities.

A set of guiding principles are defined for each of the Strategic, Tactical, and Operational layers, such that all service providers are aware of the strategic goals and business objectives of the services recipient, so that service providers understand and orientate their services provision to align with those business objectives.

An example table of contents for the overall document consists of the following introductory sections and up to three (3) additional sections, as appropriate:
Introduction: Outlines the objectives and scope of the Memorandum of Understanding and interaction Charter, and their relationship to individual Service Provider Agreements.
Context: Describes the collaborative governance approach and how the services recipient envisions this approach functioning for the benefit of all stakeholders.

### 1. Memorandum of Understanding (Strategic Level)

The Memorandum of Understanding will describe the roles, functions and responsibilities of the supervisory personnel of the services recipient, i.e. the organisation; together with how the service delivery performance of each service provider will be assessed by the services recipient. For example, the Memorandum of Understanding will specify the standards and audit mechanisms for all service providers.

Also, the engagement and disengagement processes will be defined by how service providers will participate within the Collaborative IT Governance Framework.

It will be understood that the table of contents for the Memorandum of Understanding below is only an example and that various additions, changes and modifications may be made. Accordingly, the various, roles and responsibilities, assessment and engagement and disengagement processes required of the service provider may vary.

An example table of contents for the Memorandum of Understanding section may consist of the following elements:
1. Defining the Relationship Model: Outlines the strategic goals and business objectives of the services recipient, together with the major principles of how service providers should orientate their services provision to align with those business objectives.
2. Guiding Principles: A number of guiding principles may be defined, such as how the relationships between the service providers and services recipient across the three layers of management—strategic, tactical and operational will function; and the level of interaction and collaboration expected between the participating service providers for the successful delivery of services and alignment with business objectives of the services recipient.
3. Roles and Responsibilities: Defines the specific roles, functions and responsibilities of the supervisory personnel of the services recipient, together with the correlating roles of the service providers, i.e. the interactions between the vertical towers and organisation in the model of FIG. 5A.
4. Governance Arrangements: The framework is defined according to the levels of governance. Forums are also defined in order for representatives at each level to participate in the management of the services provision.
5. Processes for Engagement and Disengagement: A number of principles can be defined to ensure that the replacement, addition or removal of certain service providers is carried out seamlessly or at least with minimal disruption to the provision of services. The principles outline how service providers can leave or join the provision of services to the organisation.
6. Assessment: An overarching set of performance measurement principles are established to measure the efficiency and effectiveness of service delivery performance and degree of alignment with the business objectives of the services recipient.
7. Maturity & Effectiveness: Outlines how the overall effectiveness of the governance model and the level of maturity of the participating parties and the organisation. A simple ‘radar’ graph shows areas of strength & weakness against specific criteria.
8. Audit: Outlines how the collaborative group can be audited. This is likely to be an external audit using an industry standard set of metrics, such as Gartner, ‘e-SCM’ or ISO20000

### 2. Interaction Charter (Tactical Level)

A set of operating principles are defined such that all service providers are aware of the rules of interaction that indicate how the service providers are to interact with each other and with the organisation for the provision of services. For example, the interaction charter may determine a set of rules that define how subscribing service providers and the organisation are able to interact in order to ensure that defined and consistent operating targets for the aggregation of the contracted services are maintained.

Also, the Interaction Charter may define what the service providers can and can't do, and what happens if the rules are not adhered to. It is understood that additional rules may be determined in order to ensure collaboration between the service providers and the organisation. These guiding principles ensure that if a particular service provided by a service provider fails to meet its requirements, the entire provision of services does not fail. Instead, the interaction charter provides a well defined set of rules for maintaining efficient, constant and seamless service provision for the organisation.

It will be understood that the table of contents for the Interaction Charter below is only an example and that various additions, changes and modifications may be made. Accordingly, the various interaction activities, roles and responsibilities required of the service providers may vary.

An example table of contents for the Interaction Charter section may consist of the following elements:
1. Group Objectives: A number of key objectives may be defined, such as how service continuity is to be achieved, what level of co-operation and collaboration should exist between certain service providers and between the organisation and the service providers, and how common infrastructure elements are managed and any resulting OLAs
2. Roles and Responsibilities: Defines the specific roles, functions and responsibilities of the supervisory personnel of the services recipient, together with the correlating roles of the service providers and will be defined through the Responsibility Matrix process. How service delivery responsibility for each service provider should align with, but not conflict or overlap, with the service delivery responsibility of other service providers; as managed by the model shown in FIG. 5A across all service providers
3. Pricing: This defines the level of transparency of the overall pricing model for the services in either a bundled or unbundled state. This allows the organisation to understand the nature of the services provided.
4. Group Performance Measures: A common set of performance measurement principles are established that are based on an industry ‘best-practice’.
5. Knowledge Management: Defines the nature and type of knowledge repositories so that information about the organisation can be accessed and shared between the providers. This assists with delivery alignment and speeds resolution of known issues. It forms the basis of the group ‘risk register’:
6. Continual Improvement: The expectation for developing service process or delivery improvements by each service provider on an ongoing basis, and the process for coordinating their implementation.
7. Interactions: Define what the service providers can and can't do, and what happens if the rules are not adhered to. It also outlines the various inputs and outputs necessary for horizontal interaction. This facilitates speed of resolution in the event of a break in delivery.
8. Review Forums: A number of forums can be defined in which service providers and the organisation can provide feedback at the various levels of management (strategic, tactical and operational) to ensure the provision of services is operating as effectively as possible.

### 3. Service Provider Agreements (Operational Level)

The Service Provider agreements are the traditional provider documents. The emphasis is on the individual contributions from providers of collections of services, their costs, performance and SLAs. This section is provided for completeness and reference.

It will be understood that the table of contents for the Service Provider Agreements below is only an example and that various additions, changes and modifications may be made. Accordingly, the various, SLAs, costs and performance measures are likely to be different for each participating service provider.

An example table of contents for the Service Provider Agreements section consists of the following elements:
1. Individual Responsibility Matrices: It is expected that the individual service provider Responsibility Matrix will be included. This provides a complete reference for all of the service providers and accountabilities.
2. Service Delivery Responsibilities: A detailed description of what services the providers of the collections of services will provide across their spheres of technology within the IT environment.
3. Service Provider Performance: Individual measurements (ITIL & COBIT) for service provider assessment on maturity of service delivery processes and alignment to organisation business objectives. The purpose is to meet contractual arrangements and to provide guidance on any remedial programmes.
4. Costs: A view & breakdown for individual costs of the services by the individual service provider to facilitate pricing transparency to the organisation across group services.
5. Service Level Alignment: How service levels for each service provider should align with those of other service providers and the IT and business objectives of the services recipient.

FIG. 5B shows an example screenshot of a JRM Builder Tool similar to that which was described in the applicant's earlier filed patent applications US2006/025677, US2006/025686, US2006/025685 and US 2006/025678 by Lymbery et al. The tool 5201 includes a graphical interface, which has a list of the services 5203 associated with an organisation. In this example, the services are identified as Internet services, Licence administration, Network management, Operational services, Performance management, Pipeline management, Printing services, Procurement, Resource management, Scheduling services, Security management, Service desk (Support desk), Software distribution, Storage management, System software support, Third party management, etc.

Each service may be broken down into tasks to indicate how the service is to be implemented. In the example shown in FIG. 5B, the support desk service is broken down into the following tasks: Call logging, Incident management, Incident diagnosis and User access management.

For each service, the contracted party 5205 and delivering party 5207 are identified as being responsible for the provision of that service within a defined element of the organisation's environment. In this example, the defined elements of the organisation's environment include Desktop services, Exchange, WAN (Wide Area Network). LAN (Local Area Network), Help desk (Support desk) and asset management, Data centre LAN and Data centre servers.

FIG. 5C shows an example of a Responsibility Matrix used according to this embodiment. The matrix 5301 is similar to that described in the applicant's earlier filed patent applications US2006/025677, US2006/025686, US2006/025685 and US 2006/025678 by Lymbery et al. A list of services 5303 and associated tasks are defined vertically in a left hand column. The organisation's environment is defined and displayed horizontally as a list of elements 5305. At each intersection point 5307 of a service and organisation's environmental element an indication is provided to show which service provider is responsible for providing the service according to a key 5309.

Referring back to FIG. 5A, a list of event driven functions used in this particular embodiment is defined according to a common standard as follows: Incident management, Problem management, Change management, Release management, Configuration management, Capacity management, Availability management, Continuity management, Financial management, Service level management and Account management. Processes are defined for carrying out the event driven functions. In this embodiment, the processes are aligned with ITIL as provided by OGC (Office of Government Commerce) and as indicated on their website at http://www.itil.co.uk/. It will be understood that the list of event driven functions and their associated processes may be changed or modified depending on the requirements of the organisation.

Details of the breakdown of an event driven function are provided as an example in FIG. 5D. Each process 5401 is split into associated activities 5403. For example, the Incident management process 5401 is split into the activities Scope, Incident Control, Incident Resolution and Service management interfaces. For each activity, sub-activities are defined for carrying out that activity. Each sub-activity has a defined procedure for executing the sub-activity. For example, for the activity ‘Scope’ a sub-activity identified as ‘Incident management plan’ 5405 is provided. A procedure is then defined for executing this sub-activity. The procedure enables the ‘Scope’ activity of the incident management process to be implemented. Further examples of sub-activities are shown in FIG. 5D and include Detection & Recording, Classification & Initial support, Investigation & Diagnosis and Ownership, Monitoring, Training & Communication.

Referring back to FIG. 5A, a list of business as usual (BAU) driven functions used in this particular embodiment is provided as follows: Supply provisioning, On-site support, Software management, ICT facilities management, Storage and data management, Systems administration, Output management, Network administration, Event management, Security management, Applications support and Application administration. It will be understood that the list of business as usual driven functions may be changed or modified depending on the requirements of the organisation.

Details of the breakdown of BAU driven functions (ICT services) is provided in FIG. 5E. Each BAU driven function, or service, 5501 is split into a number of separate activities 5503. For example, the Systems administration service 5501 is split into the separate activities of Directory services administration, Infrastructure application administration and Operating Environment Support. For each separate activity, a sub-activity is defined for carrying out that service. For example, for the activity Operating Environment Support, sub-activities are identified as Installation & Maintenance, Management & Support, Security Patch Management, Systems Programming & Scripting and Production Scheduling. Task lists are then provided that include a list of pre-defined tasks in order to carry out the service.

Referring back to FIG. 5A, collections of services 509 are defined which categorise the organisation into distinct areas. The responsibility of providing services or processes associated with the collections of services is allocated to several service providers. Each collection of services is shown as a separate vertical tower placed up against and aligned with the service delivery functions. One service provider may be associated with one or more collection of services. For example, one of the multiple service providers may be allocated to provide services or processes to a number of different areas of the organisation. In this embodiment, the collections of services are identified as a service desk (support desk), desktop services, operational services, network services, procurement, performance monitoring, and IT continuous business. It will be understood that the list may be changed or modified depending on the requirements of the organisation.

Referring to the business as usual driven functions (ICT services) 507 in more detail, a metric in the form of a visual indication 511 is provided in the columns or towers indicating whether the service provider associated with the collection of services is responsible for the corresponding service forming the business as usual driven functions. If the service provider is responsible, a visual indication, a tick in this embodiment, is placed at the intersection point where the ICT service meets the collection of services. If the service provider is not responsible, a different indication, a cross in this embodiment, is place at the intersection point. This therefore provides a clear indication of which service providers are allocated responsibility for each of the ICT services across the organisation. It will be understood that other types of visual indications may be used to show whether a particular service provider is responsible for providing a particular service. For example, the visual indication may be a particular colour to indicate the presence or absence of the assignment of responsibility, or may be the inclusion of any suitable symbol to indicate the assignment of responsibility.

Further metrics 513 are inserted at intersection points where the ICT services meet the collection of services. The metric used in this embodiment is a CobiT aligned metric, which is shown in more detail in FIG. 5F.

In FIG. 5F the metric provides measured values associated with the service performance. The CobiT aligned metric provides an indication of the level of implementation and performance for each service in relation to each collection of services associated with a service provider that is responsible for providing that service. Values are provided for the service delivery performance in the form of a Key Performance Indicator (KPI) 5501, the service delivery outcome in the form of a Key Goal Indicator (KGI) 5503 and a maturity value in the form of a maturity level value 5505.

Referring back to FIG. 5A, for the event driven functions 505, metrics in the form of indications (515, 517) are provided at the intersection points where the event driven functions meet the column indicating the collections of services. The indications indicate whether the service provider associated with a particular collection of services is responsible for the corresponding process forming the event driven function. One such indication in this embodiment is an ITIL process maturity metric 515, as shown in more detail in FIG. 5G. A further such indication is an ARCI matrix metric 517, which is shown in more detail in FIG. 5H.

FIG. 5G shows the ITIL process maturity metric in the form of a graph. The graph indicates the different levels of implementation for specific aspects of processes forming the event driven functions. For example, as shown in FIG. 5G, measurement values are given for the maximum attainable score, and a score for the organisation for pre-requisites, management intent, process capability, internal integration, products, quality control, management information, external integration and customer interface. This enables the organisation to determine how well implemented the processes forming the event driven functions are.

In FIG. 5H indications are provided within an ARCI matrix as to who is accountable, responsible, to be consulted and to be informed for event driven functions for each collection of services. For example, the organisation (client) themselves may be listed as being accountable for the activities associated with the Incident Management process in relation to desktop services, whereas one of the multiple service providers may be responsible for these activities. Referring back to FIG. 5A, for each of the event driven functions shown it becomes possible to visually identify each function along the entire service provider chain shown along a horizontal line within the model. For example, the change management process is shown with a dashed box indicating the responsibilities and metric calculations for the process across the multi-sourced environment. At each intersection point with a collection of services, metrics are inserted according to the negotiations between the organisation and the multiple service providers. In this manner, a total predicted metric value 519 can be obtained for a particular event driven function across the entire multi-sourced environment. In this embodiment, the total metric value is an overall ITIL process maturity metric, which is shown in more detail in FIG. 5I. However, it will be understood that the metric used may be any other suitable metric.

FIG. 5I shows the overall ITIL process maturity level across all service providers. The level ranges are indicated as nothing present or intended, pre-requisites, management intent, process capability, internal integration, products, quality control, management information, external integration and customer interface. The overall measurement is calculated from all the individual ITIL process maturity values 515 that were inserted into the model at the intersection points during the negotiations. By looking at the total values, it is possible for the organisation to determine if the overall value of a certain metric coincides with its overall requirements for a particular event driven function. If not, the organisation can then revert back to any one of the multiple service providers to re-negotiate part of the associated service agreement in order to change the relevant specific metric, which will in turn change the overall metric value.

For each collection of services shown in FIG. 5A, a total metric value 521 is provided at the bottom of each vertical row associated with the collection of services. The total metric value provides an indication of how the implementation or operation of those services has changed over time for that specific collection of services. In this embodiment, for each defined collection of services, the CobiT Maturity metric is provided to show the extent to which the implementation of the services for that collection of services has changed over time. An indication is provided to show a previously determined level of implementation for the defined collection of services, as well as a current measure of the level of implementation. These values are determined using a service level performance measure for the defined collection of services. It will be understood that other suitable metrics may be used.

FIG. 5J shows the CobiT Maturity metric in more detail. The metric values provide an indication of the service level performance for each collection of services. The rating values provided include: non-existent; initial/ad-hoc; repeatable; defined process; managed and measurable; optimised.

Referring back to FIG. 5A, an overall CobiT maturity level 523 is provided to give an indication of the service level performance across all collections of services for all technology based services provided in the multi-sourced environment.

Also provided in the model are a number of process touch points 525. These process touch points enable a smooth transition between different collections of services when carrying out a defined process for an event driven function. That is, the process touch points 525 are a ‘gap filler’ that define the inputs and outputs between the service providers of the collections of services, or between the service providers and the organisation, in terms of defining who gives what to whom and when, or who does what for whom and when. The process touch points can be measured in terms of outputs (reports, statistics, data or event feeds) or outcomes (a service that is available for others to use). Further, the process touch points enable a mechanism for information to be passed back to the organisation at each intersection with a collection of services. An embodiment of a process touch point is shown in more detail in FIG. 5K.

FIG. 5K shows the handover from a process sub-activity carried out by the organisation 5601 to a process sub-activity carried out by a service provider 5603. The touch points define how an interaction takes place between different service providers, or between the service providers and the organisation. Each sub-activity itself is defined in terms of the procedures 5605 to be carried out. Further explanation concerning the implications of using touch points is now provided.

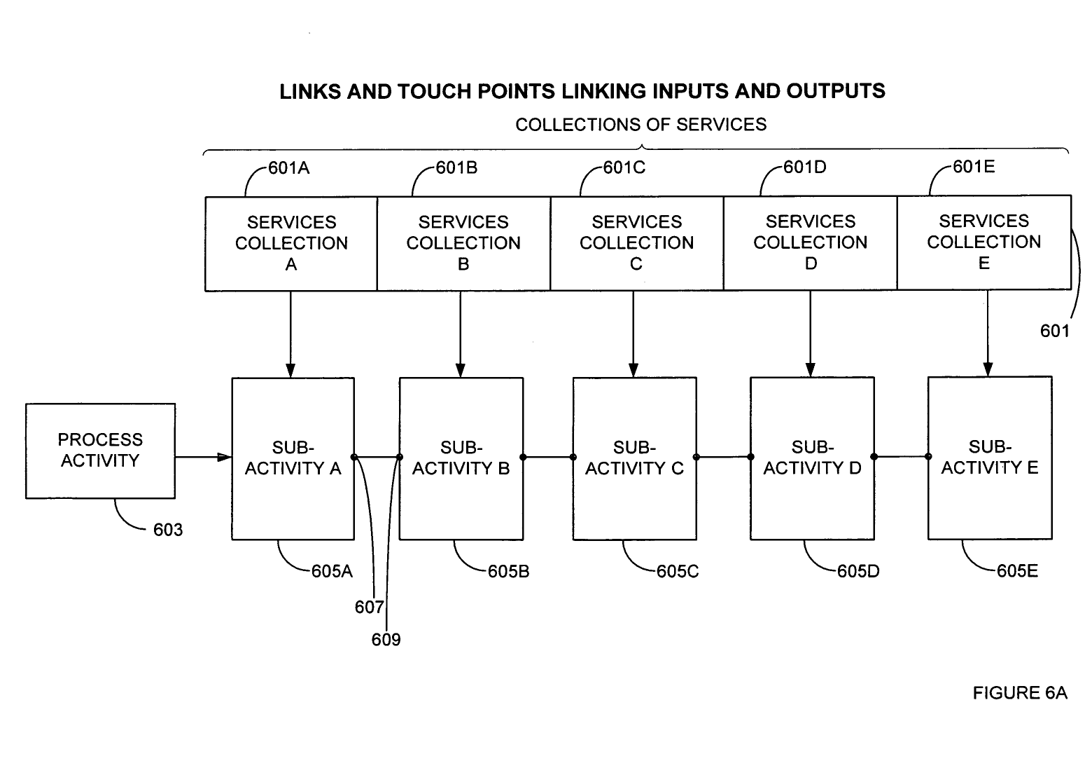

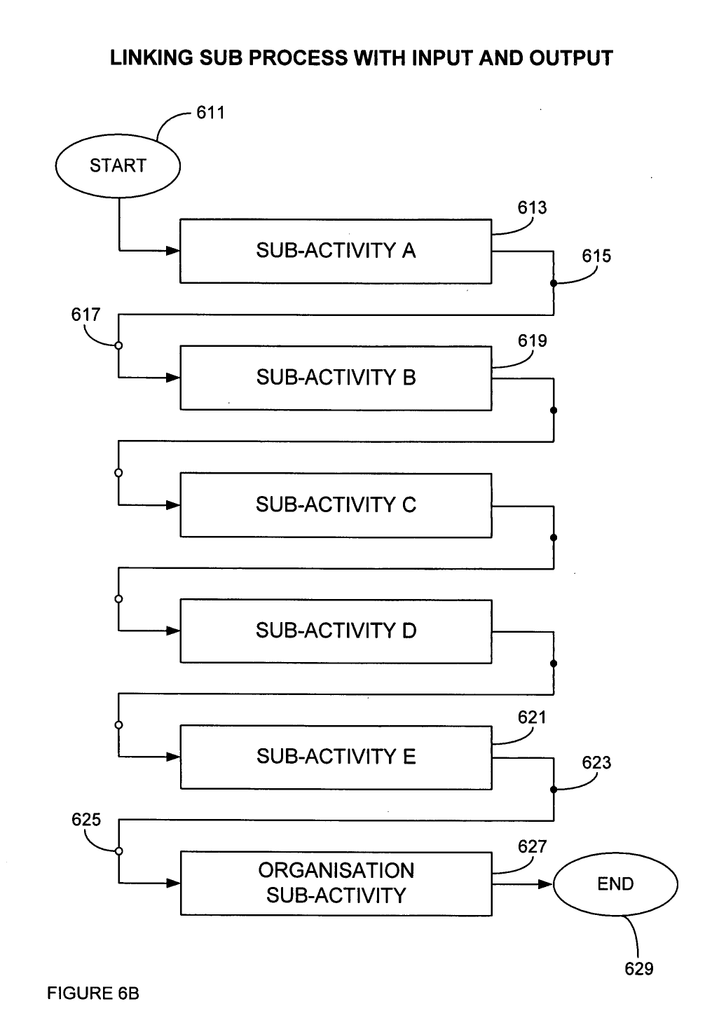

FIG. 6A shows a pictorial representation of links, or touch points, that link interdependent inputs and outputs of process sub-activities. Several service providers are allocated responsibility to provide collections of services (601A-E). A process for an event driven function is implemented by any number of service providers. The process is defined by a number of process activities. Each process activity 603 is split up into distinct sub-activities 605A-E. Each sub-activity is associated with a specific collection of services. For example, a first collection of services 601A has a first sub-activity 605A associated with it in order for the service provider associated with that collection of services to carry out the required procedures associated with the sub-activity for that part of the organisation. Once the procedures associated with the first sub-activity 605A have been implemented, the output 607 of the sub-activity links with an input 609 of the next corresponding sub-activity 605B such that the inputs and outputs are interdependent. The interlinking or interdependent mechanism allows a smooth transition from running the first sub-activity to running the second sub-activity, and so on. The output of one sub-activity is arranged to be interdependent, or corresponding to, the input of the sub-activity which follows.

FIG. 6B shows a flow diagram of linking sub-activities with interdependent inputs and outputs that are to be carried out by several service providers. In this embodiment, a further sub-activity is indicated as carried out by the organisation. The activity associated with a process starts at step 611 and a sub-activity A 613 is executed by a service provider. Upon completion of the sub-activity A, the output 615 is interdependent with, and so links to, the input 617 of sub-activity B 619. Sub-activity B is carried out by another service provider. This continues through to sub-activity E 621, where the output 623 is interdependent with, and so links to, the input of an organisational sub-activity 627. Once the organisation completes its sub-activity, the activity ends 629. It will be understood that there may be more than one organisation sub-activity, or multiple organisation sub-activities of the same form, that are accessed during the execution of the activity 603. Further, any organisation sub-activity may be accessed at any point such that it is interdependent with an output of one of the service provider sub-activities.

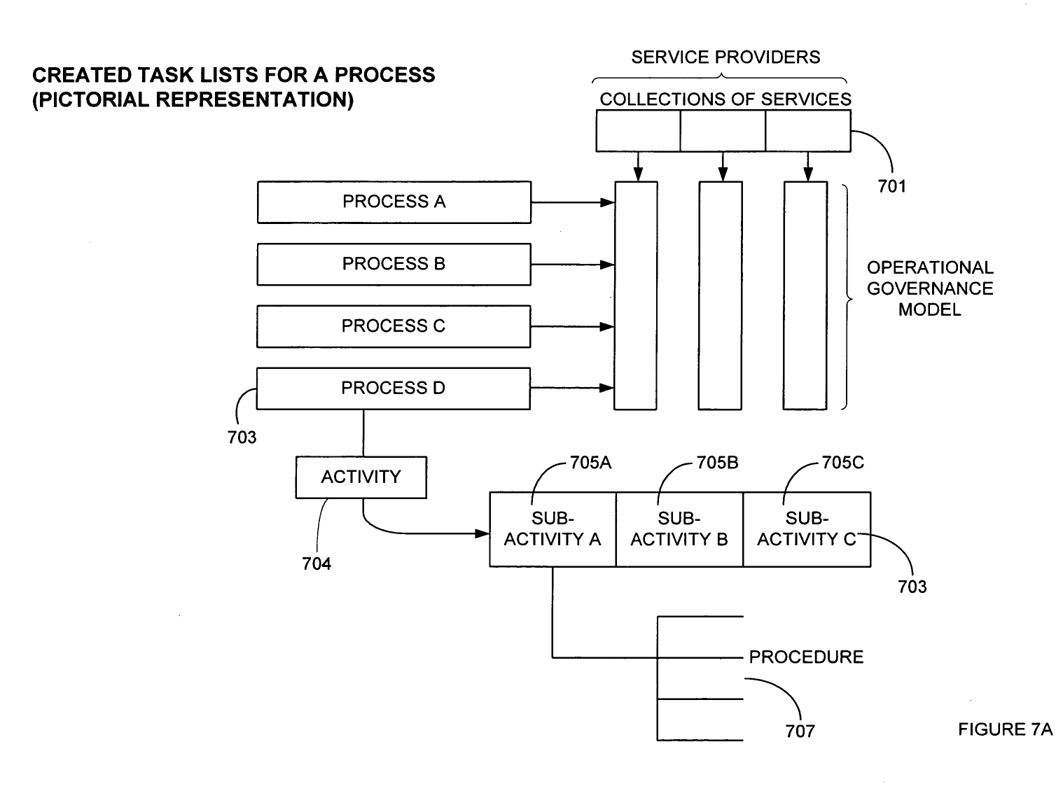

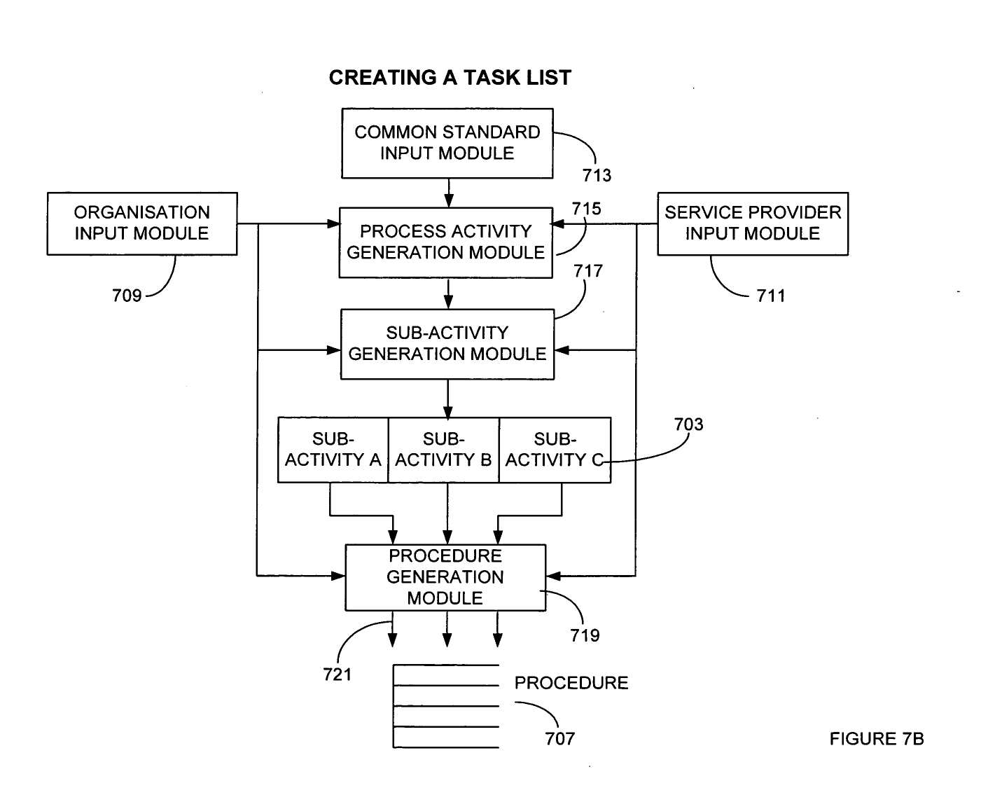

FIG. 7A shows a pictorial representation of creating a procedure for a process according to this embodiment.

Several service providers 701 are arranged to provide particular collections of services. Numerous processes 703 are also defined. For each process a number of activities are defined. Only one activity 704 is indicated for clarity purposes. For each activity 704, multiple sub-activities (705A-C) are defined. For each sub-activity 705A, a procedure is defined that enables service providers to implement the sub-activity 705. The procedures 707 are defined in line with a common standard. The procedure thus provides a detailed list of instructions to the service providers in the multi-sourced environment on how to complete the sub-activities whilst being aligned with a common standard.

FIG. 7B shows a flow diagram for creating a procedure for a process. An organisational input module 709, a service provider input module 711 and a common standard input module 713 provide information to a process activity generation module 715. The organisational input and service provider input are obtained during the negotiation stages for the multi-sourcing agreement. The process activity generation module 715 outputs a number of process activities based on the received information. A sub-activity generation module 717 receives the process activity information from the process activity generation module as well as receiving input from the organisation and service provider input modules (709, 711). Information from the organisation and service provider input modules may be used to define the sub-activities. A number of sub-activities 703 are generated within, and output from, the sub-activity generation module. Each sub-activity is input into a procedure generation module 719, which also receives input from the organisation and service provider input modules (709, 711). The procedure generation module 719 generates and outputs 721 a procedure 707 that defines how the sub-activity is to be implemented.

It will be understood that the same methodology used in generating procedures for processes can also be implemented for generating task lists associated with service sub-activities related to the business as usual service delivery functions. The task lists or procedures provide instructions on how to implement the service or process sub-activities. That is, a service is defined by a number of service activities. Each service activity is defined by a number of sub-activities. For each sub-activity a task list is produced clearly defining the required steps for the associated service provider to carry out the service.

Using the above defined model, it becomes possible to retrieve information identifying the current performance levels for a process or service as provided by one of the service providers. The current performance level information is based on retrieved metrics. Using this information, an organisation can monitor the performance levels of various processes or services, and/or service providers in relation to specific collections of services. If required, the organisation may make changes to how a process or service is being delivered, or change service providers for areas of the business where the performance level does not come up to the organisations expectations.

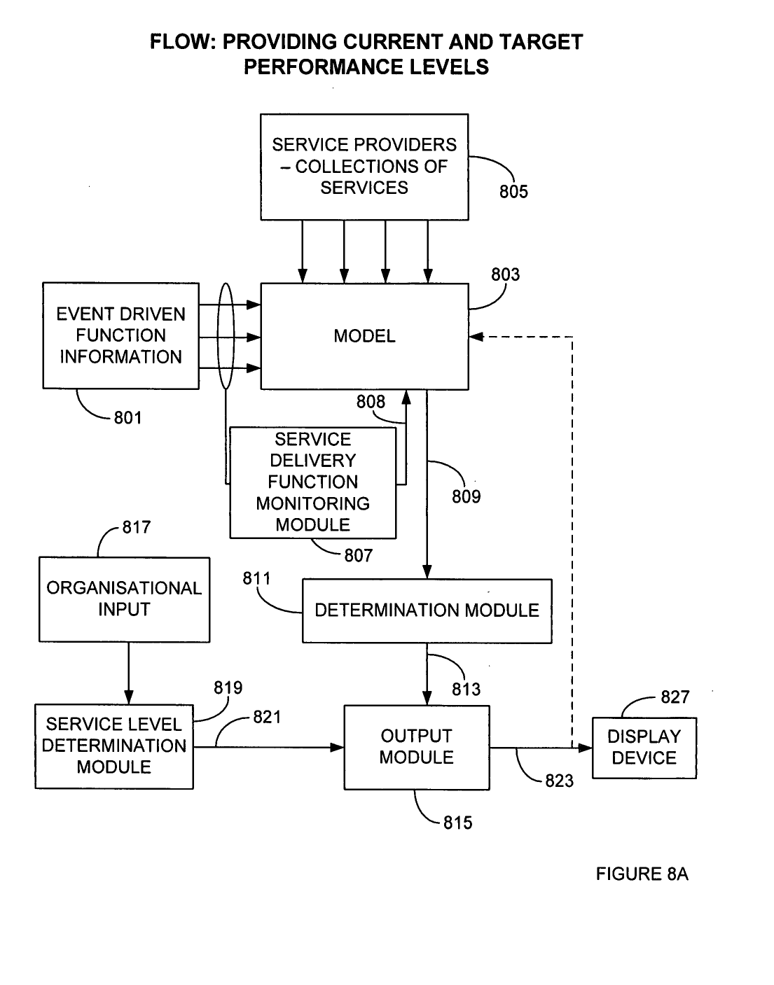

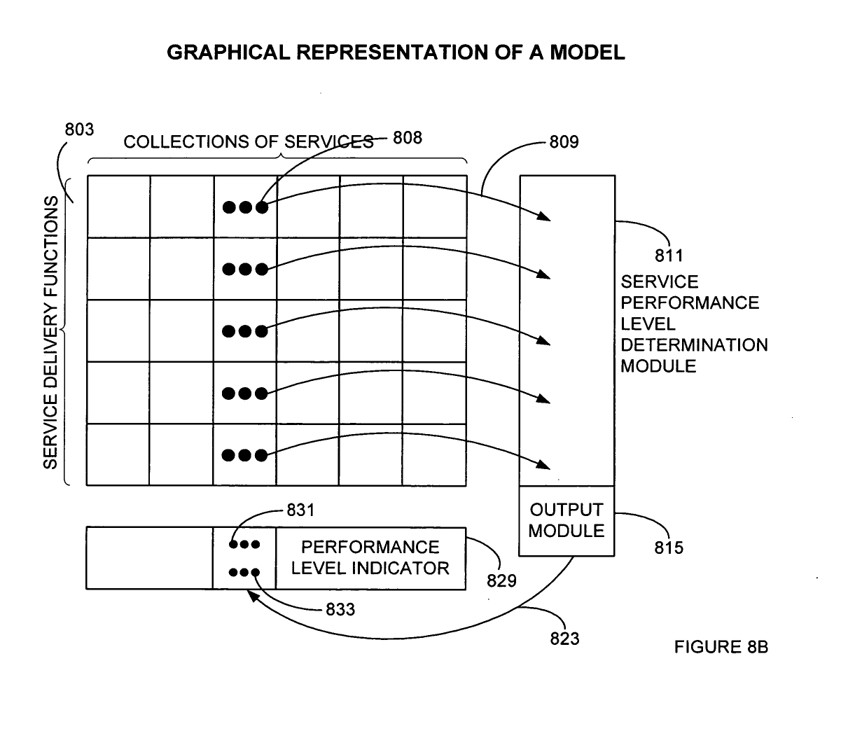

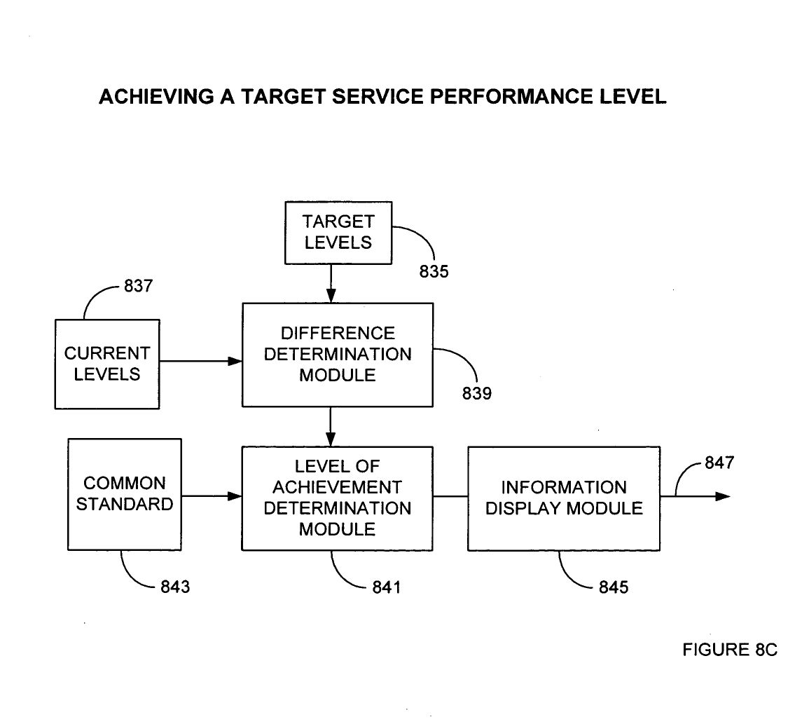

FIG. 8A shows the flow of information for providing current and target performance levels for a specific collection of services. A number of event driven functions are defined as explained above, and information 801 concerning those functions as obtained during negotiations is inserted into the model matrix 803.

Several service providers 805 are associated with one or more collections of services in order to populate the model matrix 803. A service delivery function monitoring module 807 accesses process information as the event driven functions are being implemented. For example, the service delivery function monitoring module 807 may retrieve feedback from the organisation or service providers on how a particular process is performing based on a pre-defined metric. The metric 808 is output from the service delivery function monitoring module 807 and is placed into the model to indicate the current performance level of the process. The metrics are provided for all processes associated with a particular collection of services. This provides a model matrix 803 populated with metrics for a particular collection of services with the purpose of providing information on how the service provider is performing in regard to that collection of services and the provision of the associated processes for the event driven functions.

In order for an organisation to monitor the difference between the current performance level and a target performance level for a particular collection of services, a determination module 811 extracts the metric information 809 for all processes associated with a collection of services from the model. A current service performance level 813 is determined by the current service performance level determination module 811, and is provided to an output module 815. Meanwhile, organisational input 817 is received by a target service performance level determination module 819 in order to provide a target service performance level 821 as defined by the organisation. The organisational input may be derived from information received during the service performance level negotiation stages, or alternatively may be derived from a subsequent meeting within the organisation arranged to renegotiate target service performance levels.

The target service performance level 821 is provided as an input to the output module 815. The output module 815 provides an output 823 that identifies the differences between the current and target service performance levels. The output may be displayed on a display device 827 within the graphical user interface as described above. Further, the output 823 provided may be used to modify the information inserted into the model matrix 803 as it was defined during the negotiation stage, and provide changes to the service level agreements, define new technology based services or change service providers.

FIG. 8B shows a graphical representation of the model as displayed on a user interface for showing the target and current service performance levels as described above. The model matrix 803 includes metrics 808, such as the CobiT metric indicating performance level, at each intersection point where a service delivery function corresponds with a collection of services associated with one of the multiple service providers. The metric information 809 for a collection of services is extracted and the current service performance level is calculated by the current service performance level determination module 811. The output module 815 provides the output 823 to enable the current performance level 831 and target performance level 833 to be displayed on the graphical user interface in a target service performance level indicator bar 829.

Using the target and current service performance levels, information is provided to an organisation to enable the organisation to reach its desired target from its current performance level.

FIG. 8C shows a flow diagram for providing information on how to achieve a target service performance level. Target service performance levels 835 and current service performance levels 837 are obtained as described above and are provided to a difference determination module 839. The difference determination module 839 provides an output that identifies the difference between the current and target service performance levels. The output is provided to an achievement level determination module 841 along with information 843 associated with a common standard. The achievement level determination module 841 provides information on how to achieve the target service performance level based on the current service performance level. The information is linked with a common standard in order to ensure that any changes made to the service delivery functions align with the common standard. The information is forwarded to an information display module 845, which displays the information 847 for the organisation so they can achieve their target service performance level.

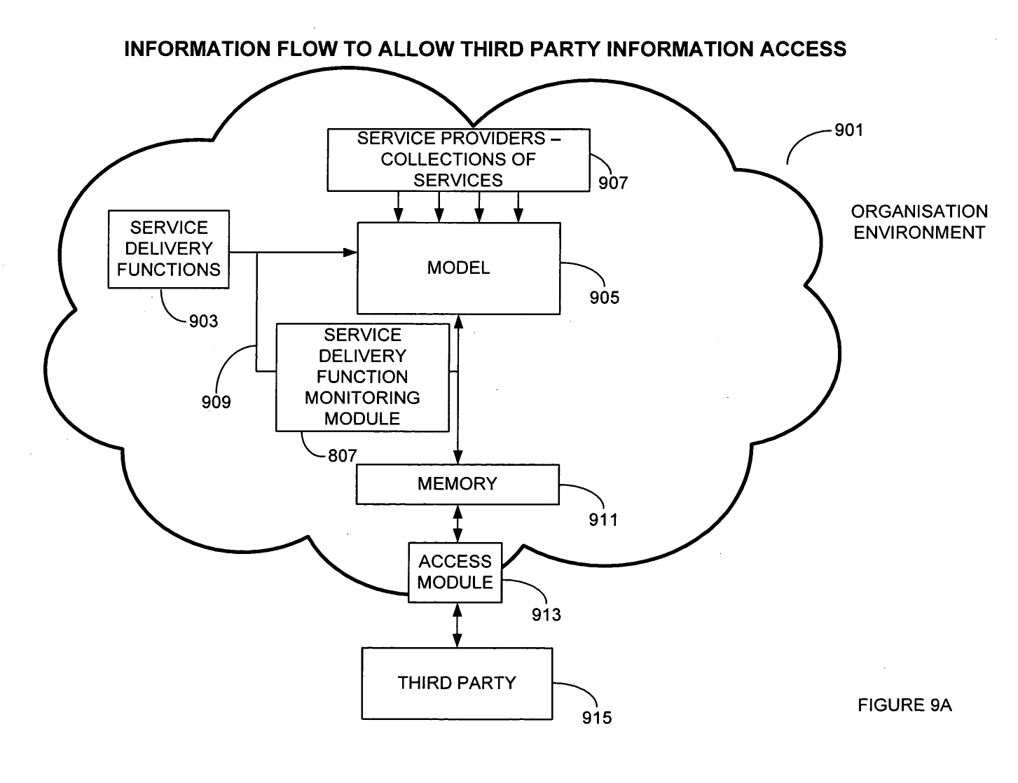

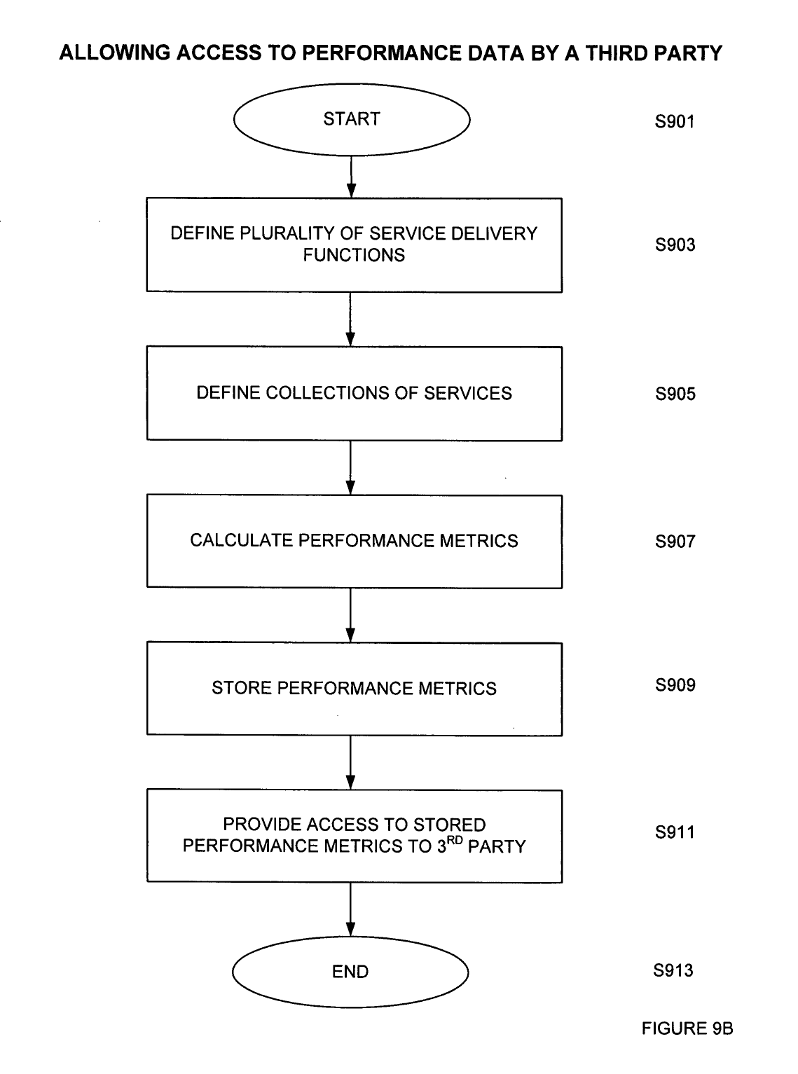

Certain organisations require third parties to acquire information concerning the operation of their business in order to carry out an audit, for example. FIG. 9A shows the flow of information for allowing a third party to access performance data according to this embodiment. The organisation environment 901 is modelled as described above. That is, a number of service delivery functions 903 are aligned with a common standard and provided to the operational governance model 905. Several service providers 907 associated with providing the service delivery functions in relation to a number of defined collections of services are also identified in the model 905. Performance information 909 is retrieved by a service delivery function monitoring module 807, in the same way as that described above in relation to FIG. 8A, while the service delivery functions are being carried out, as described above. This information is used to provide metrics to the model 905. The metric information is also stored in a memory store 911. A third party 915 can access the memory store 911 via an access module 913. The access module 913 provides a level of security to stop the memory store from being accessed by unauthorised parties. Any suitable type of authorisation may be carried out to allow access through the access module. In this embodiment, the third party 915 accesses the memory store through an Internet connection and a website operated by the organisation by using passwords previously obtained from the organisation. Alternatively, it will be understood that the third party may access the information using any other suitable means.

FIG. 9B shows a flow diagram for allowing a third party to access performance data associated with a multi-sourcing environment. The method starts at step S901. Service delivery functions are defined at step S903 in line with one or more common standards. Collections of services are defined at step S905 in line with the organisations business environment. The collections of services are associated with several service providers that are allocated responsibility for the provision of the service delivery functions. At step S907 the service delivery function monitoring module 807 accesses information as the service delivery functions are being executed and calculates performance metrics based on the accessed information. The performance metrics are stored at step S909. Access to the stored performance metrics is provided to a third party at step S911. The method ends at step S913.

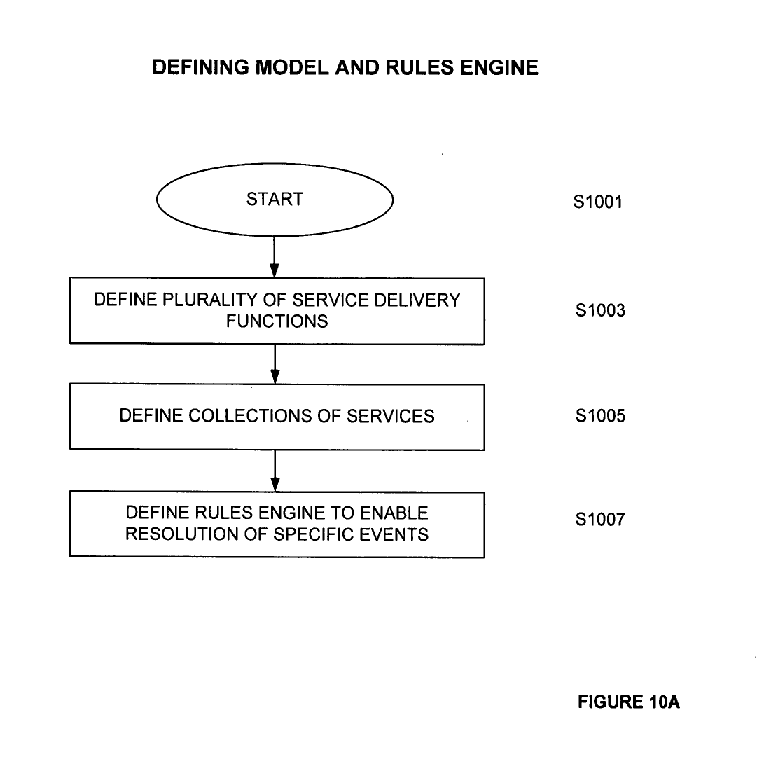

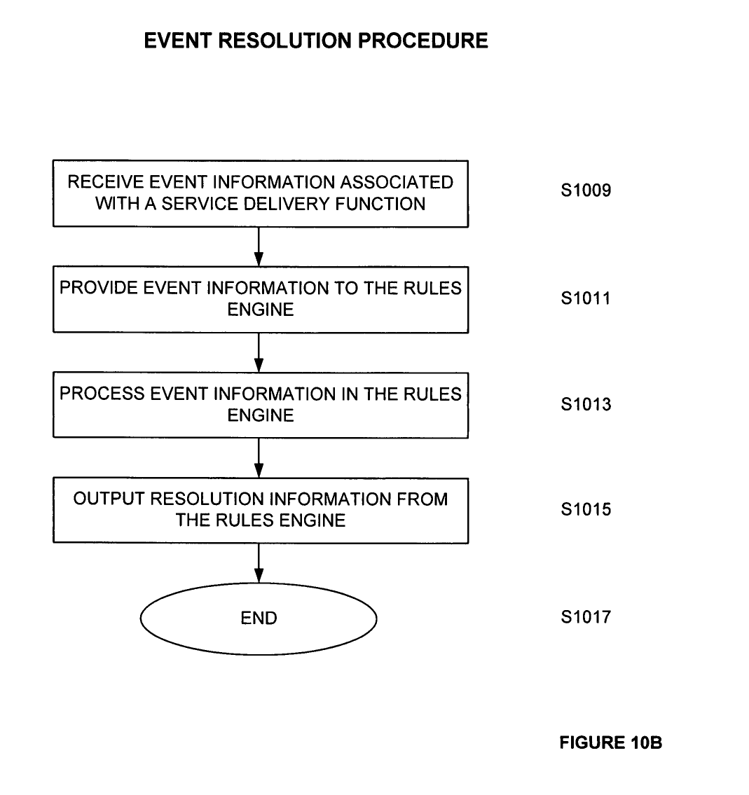

FIG. 10A shows a flow diagram of the initial stages of defining the model and rules engine for resolving specific events.

The procedure starts at step S1001, whereupon, at step S1003 a plurality of processes are defined as part of the event driven service delivery functions.

At step S1005 collections of services associated with several service providers are defined.

The next step, S1007, involves defining a set of rules that will enable the resolution of a specific event. Each function defined in the ‘event driven’ section of the operational governance model is, as the name suggests, driven by a particular event. For each event driven function, a process is defined to perform that function. For example, if an event occurs within the organisation that is outside the normal remit of the organisation's activities, a customer within the organisation will telephone a support desk to report the event and request help. The procedures followed when events are reported are part of the Incident Management process as defined in the operational governance model above. For a particular event, specific procedures for that event are followed in order to resolve the issue at hand. For example, if the customer telephones the support desk because their e-mail system is failing to send e-mails, the support desk will follow a set of procedures to enable the correct diagnosis of the problem resulting in the correct procedures for remedying the problem. The set of rules for the resolution of that particular event are stored in a rules engine which is accessible by the support desk.

FIG. 10B shows a flow diagram of an event resolution procedure for use in a multi-sourced environment. The procedure is designed to provide information to an organisation on how to resolve particular events. The information provided is directly associated with the event in question and is intended to give the organisation efficient means to resolve that particular event.

At step S1009, information about the event is received by the support desk as a single integrated point of contact. The support desk may receive this information through any of the usual communication channels. In this embodiment, the support desk receives a telephone call from the customer, i.e. a person working within the organisation, informing them of the e-mail failure. The event is logged by the support desk and an event identification number is provided to the customer for future identification of the event. All the information associated with the event is gathered by the support desk according to the Incident Management defined process.

At step S1011, the event information is provided to the rules engine. In this embodiment, the information is provided to the rules engine by the support desk operative after the event is logged. The information is submitted to the rules engine in a predefined format. The rules engine is located on the support desk operative's personal computer as an installed program. However, it will be understood that the rules engine may be located on any other computing device, and may be accessed either locally or from an external location using any known communication devices.

The rules engine processes the event information at step S1013. The rules engine outputs a series of questions for the support desk operative to answer based on the previously received information. The questions are displayed on the operative's computer screen via a graphical interface. As the answers are fed into the rules engine, a further output is provided to the graphical interface requesting further information. As an alternative, it will be understood that the support desk operative may provide the information to the rules engine at the same time as the customer is reporting the event.

At step S1015, when all the relevant information concerning the event has been entered into the rules engine, the rules engine provides information that informs the support desk operative how to resolve the event. The resolution information provided is specific to the event information received and so enables efficient resolution of the event. This resolution information is either forwarded to the customer, or to a relevant service provider, for the event to be resolved.

The procedure ends at step S1017.

It will be understood that the rules engine can also, or alternatively, provide event resolution information including identification information for identifying the entity responsible for the area of the organisation in which procedures are required to be carried out to resolve the event. That is, an individual, or a department, may be identified by the rules engine so that the operative may forward the relevant information to the correct area of the organisation or service provider.

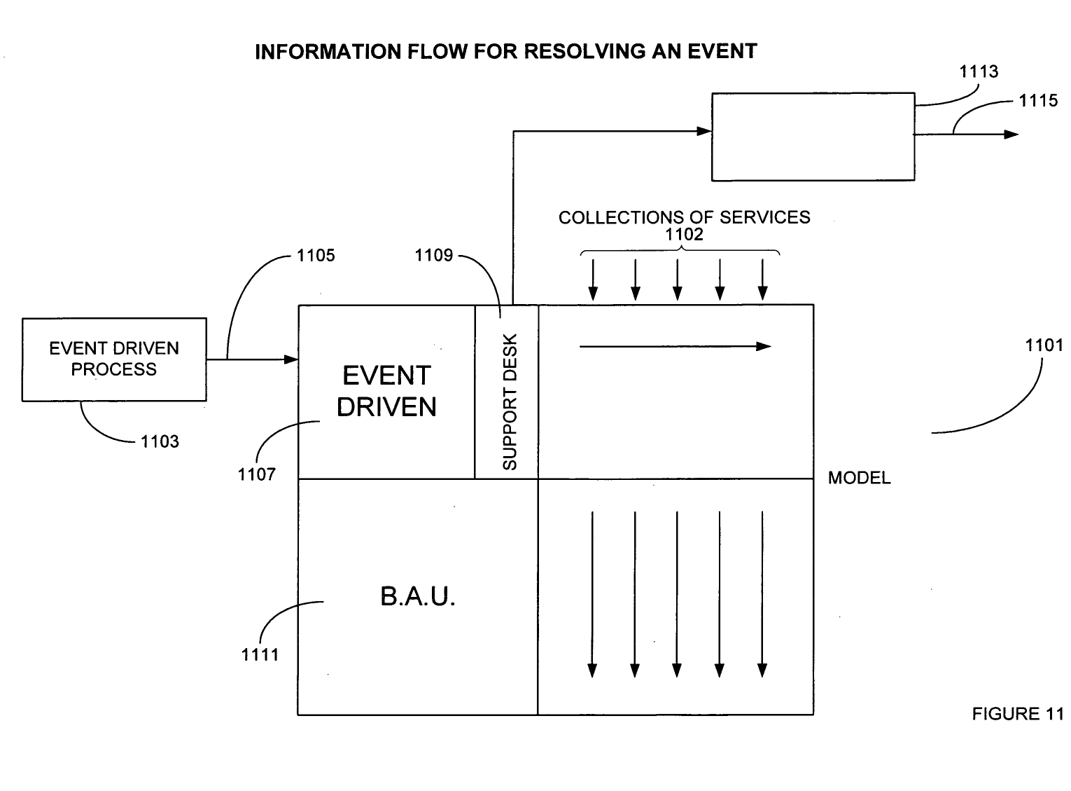

FIG. 11 shows the flow of information for resolving an event according to the procedure described above in relation to FIG. 10. The operational governance model 1101 includes a number of defined collections of services 1102 as supported by several service providers. An event driven process 1103 includes event information 1105. The model 1101 includes a list of defined event driven functions 1107 and ‘business as usual’ services 1111 as explained above. The receipt of event information 1105 triggers a process as part of the event driven functions 1107 of the model. A support desk 1109 receives the event information 1105 and forwards this to the rules engine 1113. The rules engine processes the event information as discussed above and outputs the resolution information 1115.

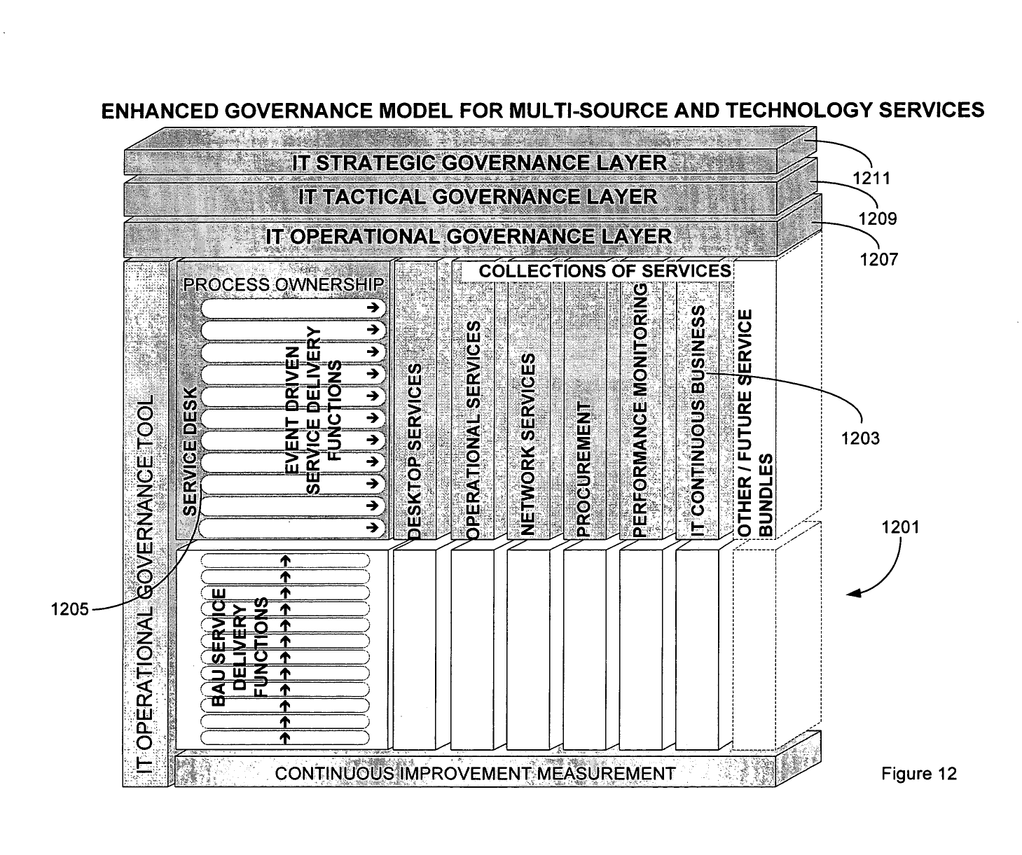

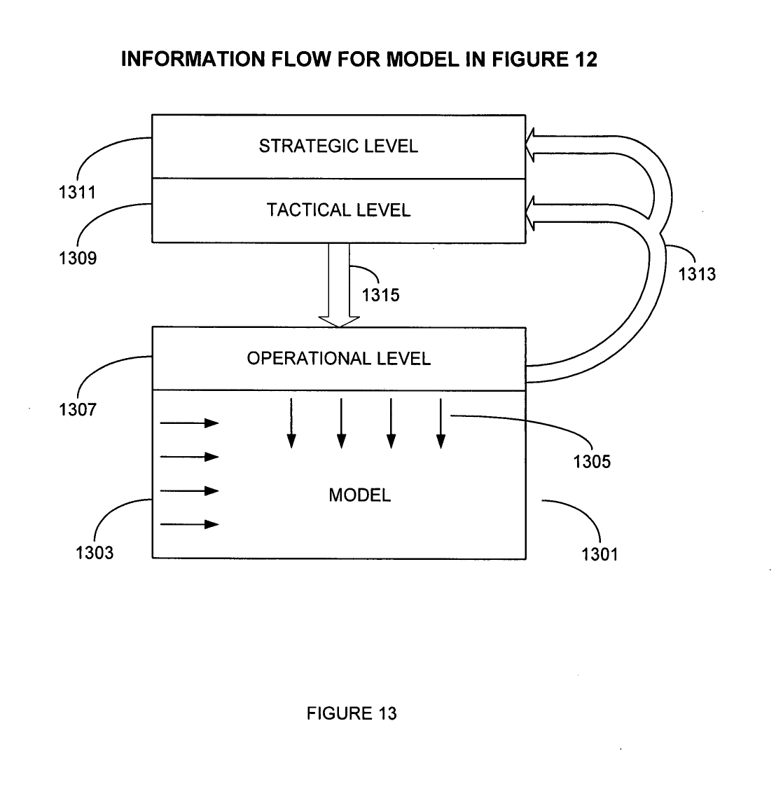

FIG. 12 shows an enhanced governance model for governing a multi-source Information Technology (IT) environment. It will be understood that the model may be applied to any other type of multi-sourcing environment.

The model 1201 incorporates the collections of services 1203 and service delivery functions 1205 of the operational governance model for an organisation as discussed above. An IT Operational Governance Layer 1207 controls the overall operation of the service delivery functions for specific collections of services as allocated to several service providers. The IT Operational Governance Layer 1207 is akin to service delivery management, and controls elements such as IT operations management, Operations infrastructure, Application support, Project management and Issues management.

The IT Operational Governance Layer 1207 is responsible for the everyday operations of the service delivery functions and reports to a higher level of governance, the IT Tactical Governance Layer 1209. The aim of the IT Tactical Governance Layer 1209 is to solve particular problems or to reach certain defined objectives associated with the operation of the organisation. The IT Tactical Governance Layer 1209 provides a service level management which includes the managing of innovation within the organisation, ensuring that the service delivery functions provide continued value and continuous improvement, as well as providing a level of risk management. The IT Tactical Governance Layer 1209 feeds information down to the IT Operational Governance Layer 1207 as well as keeping an IT Strategic Governance Layer 1211 informed of any changes.

The IT Strategic Governance Layer 1211 determines and monitors the long term plan for the organisation. This layer includes account management, which involves understanding the focus between the service providers and the organisation and controlling the relationship management. Any strategy changes are provided to the IT Tactical Governance Layer 1207 in order for that layer to determine how to implement the changes.

When defining how an organisation is to operate in a multi-sourcing environment, it is very important to define the roles within each governance layer of the organisation in a clear manner to avoid any confusion as to which person or department is responsible for particular elements of the organisation. The definition of a role includes definitions of the responsibilities for specific service delivery functions as well as the functions required of the person or department for carrying out the role. Further, it is important to ensure that there is collaboration between the different levels of governance so that correct changes are made to the operational model when changes are made at the higher levels of governance. Also, it is equally important for changes in the operational model to be reflected in the higher levels of governance.

FIG. 13 shows the flow of information for the above-described model. The operational model 1301 includes the defined service delivery functions 1303, defined collections of services 1305 all controlled by the operational level of governance 1307. The tactical and strategic levels of governance (1309, 1311) receive feedback 1313 from the operational level of governance 1307. The tactical level of governance 1309 sends information 1315 to the operational level of governance 1307.

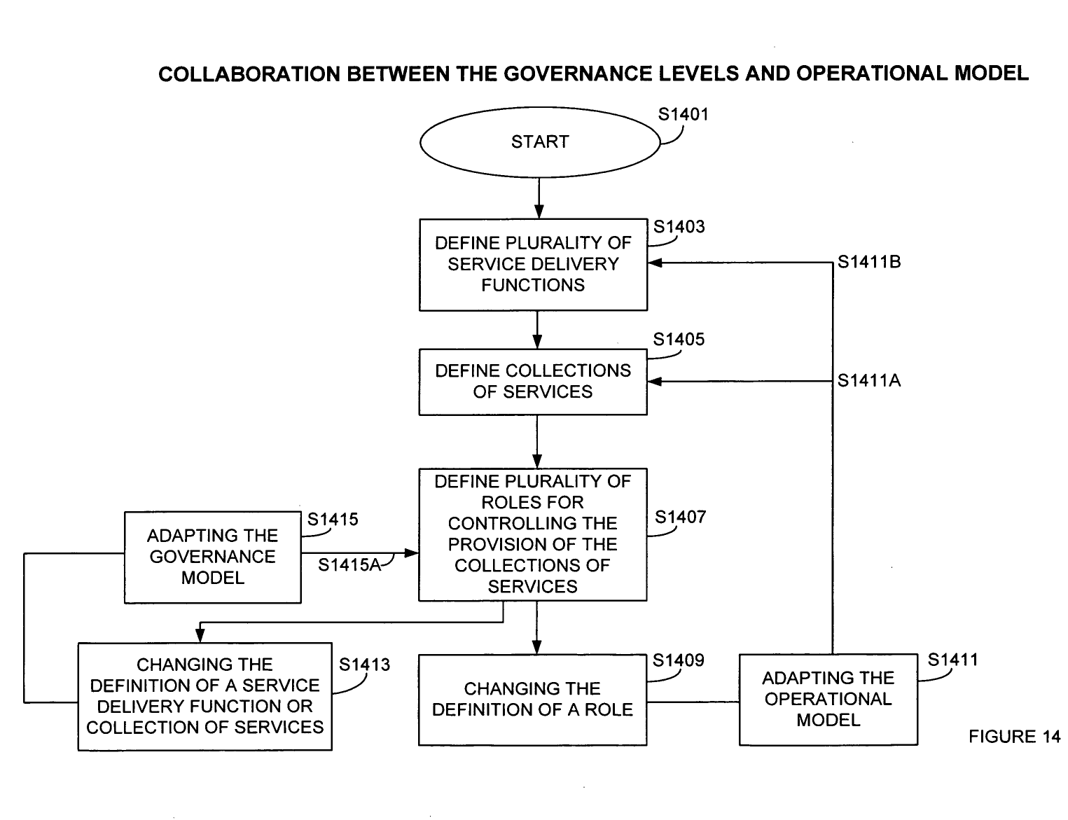

FIG. 14 shows a flow diagram showing how collaboration occurs according to this embodiment between the governance levels of a multi-sourcing environment and the operational model defining the service delivery functions and the collections of services. Roles can be redefined, added, removed or modified in any other suitable way in the governance model based on changes made to the service delivery functions at an operational level. Further, changes can be made to the service delivery functions in a similar manner in the operational model in response to changes made to the role definitions in the governance layer. Changes to the service delivery functions in this context also includes changes to the processes forming the event driven functions as well as changes to the BAU service delivery functions. The term change in this context is intended to encompass the creation of new service delivery functions or roles.

The method starts at step S1401.

At step S1403, numerous service delivery functions are defined.

At step S1405, collections of services are defined as allocated to several service providers.

At step S1407, a number of roles, functions and responsibilities are defined in the governance layers in order to control the provision of the defined collections of services. Roles are defined for particular service delivery functions by identifying certain people or departments as being responsible for the provision of those service delivery functions. Further, functions are defined in association with particular people or departments in order for them to carry out the service delivery functions.

At step S1409, a role definition is changed. The role definition change is made at either the tactical or strategic level of governance. However, if the changes are not reflected fully in the operational model, the organisation is unable to operate efficiently due to changes not being correctly defined.

The operational model is adapted at step S1411 in line with the changes made at the governance layers, i.e. the changes made to the role definition. The operational model may be adapted by making changes, as indicated at step S1411A, to the collections of services, or by making changes, as indicated at step S1411B, to the service delivery functions. For example, if a service provider is no longer responsible for a particular collection of services, such as the provision of desktop services, the change in responsibility is indicated in the model by identifying the new service provider within the model under the definition of the collection of services.

On the other hand, if a change is made to the definition of a service delivery function or collection of services, as shown at step S1413, the governance model is adapted at step S1415. The change in the governance model, as indicated at step S1415A, includes changing the definition within the roles for controlling the provision of the collection of services where changes have been made.

Using this methodology, collaboration is maintained between the operational model and the governance layers in order to ensure that the multi-sourcing environment is defined in an efficient manner. Further, once the model has been completed, it enables suitable changes to be made in either the operational model or within the governance layers when changes are made in the respective governance layers and operational model.

According to particular embodiments, the present invention provides the following advantages.

During negotiations for multi-sourcing technology based services with service providers a clear indication is provided indicating where certain service delivery functions have not been allocated.

Further, a negotiated multi-sourced organisational environment is able to operate smoothly by ensuring transition points are interdependent for sub-activities within processes that form an event driven function, such as when handling of that process is passed from one entity to another, for example, from a service provider to the organisation multi-sourcing the technology based services.

Further, pre-defined procedures or task lists are provided for sub-activities of processes or services in order to clearly define how a process or service is to operate across all collections of services provided by the multiple service providers.

In addition, indications are provided for the current and target service performance levels in order to identify the progress of particular service delivery functions within the organisation.

Further, access to performance metrics by third parties is enabled to allow efficient monitoring and auditing of an organisation's multi-sourced environment.

Also, a rules engine enables the resolution of events in an efficient manner by identifying information that can provide the resolution of the event, such as identifying the person responsible for that area of the organisation in which tasks are required to be carried out to resolve the event.

Further, a feedback and feed-forward mechanism is provided to ensure that all levels of governance within a multi-sourced environment are able to collaborate such that changes made at one governance level affect changes made at other governance levels to enable the full integration of the changes.

It will be understood that the embodiments of the present invention described herein are by way of example only, and that various changes and modifications may be made without departing from the scope of invention.

1. A computer implemented method of assigning responsibility for multi-sourced technology based services, the method including the steps of:
defining a plurality of service delivery functions;
defining collections of services that are to be provided by several service providers;
providing metrics associating said service delivery functions with said collections of services; and
inserting said metrics into a model to indicate which of said several service providers are assigned responsibility for said service delivery functions.

2. The method of claim 1 including the step of displaying a matrix of metrics for said defined service delivery functions against said defined collections of services, wherein a space in said matrix indicates where at least one of said plurality of service delivery functions is not associated with at least one of said collections of services.

3. The method of claim 2, wherein said defined service delivery functions are positioned in said model horizontally and said defined collections of services are positioned in said model vertically to produce said matrix.

4. The method of claim 1, wherein said provided metric is inserted into said model in the form of a visual indicator.

5. The method of claim 1 including the step of retrieving said metrics from a module storing information associated with a standard level of service provided by at least one of said service providers.

6. The method of claim 1 including the step of retrieving said metrics from a module storing information received through negotiation between said client and at least one of said service providers.

7. The method of claim 1 including the step of providing a total metric value for a service delivery function for all associated collections of services.

8. The method of claim 1 including the step of providing a total metric value for a collection of services for all associated service delivery functions.

9. The method according to claim 1 including the steps of:
defining a total metric requirement for all service delivery functions in relation to customer requirements;
displaying a sum of said provided metrics for each service delivery function, and displaying said total metric requirement.

10. The method of claim 1, wherein said service delivery functions are defined according to a common or industry standard.

11. The method of claim 1 including the step of allocating said service delivery functions to one of two groups, a first group defining event driven functions and a second group defining business as usual driven functions.

12. A computer implemented method of defining service delivery functions linking collections of services in a multi-sourced technology based service environment, the method including the steps of:
defining collections of services that are to be provided by several service providers;
defining a plurality of service delivery functions associated with said collections of services;
defining process activities for executing said service delivery functions; and
defining sub-activities for implementing at least one of said process activities in relation to said collections of services, wherein at least two of said sub-activities have interdependent inputs and outputs.

13. The method of claim 12, wherein said process activities are defined according to a common or industry standard.

14. A computer implemented method of defining service delivery functions for multi-sourced technology based services, the method including the steps of:
defining a plurality of service delivery functions;
defining collections of services that are to be provided by several service providers;
generating a plurality of activities for executing said service delivery functions;
generating a plurality of sub-activities for at least one of said activities; and
generating instructions to carry out at least one of said sub-activities, said instructions providing information associated with how to execute said sub-activity.

15. The method of claim 14, wherein said activities are defined according to a common or industry standard.

16. A computer implemented method of providing a current service performance level and a target service performance level in a multi-sourced technology based service environment, the method including the steps of:
defining a plurality of service delivery functions;
defining collections of services that are to be provided by several service providers;
defining a target service performance level for at least one of said service delivery functions;
retrieving metrics associated with a current service performance level for an associated collection of services;
determining a current service performance level for said service delivery function based on said retrieved metrics; and
providing an output to indicate said current and target service performance levels.

17. The method of claim 16 including the step of displaying said current and target service performance levels.

18. The method of claim 16, wherein said service delivery functions are defined according to a common or industry standard.

19. A computer implemented method for monitoring the performance of multi-sourced technology based services for a client, the method including the steps of:
defining a plurality of service delivery functions;
defining collections of services that are to be provided by several service providers, wherein said collections of services are associated with said service delivery functions and said service delivery functions are defined according to a common standard across all associated collections of services;
calculating and storing performance metrics for said service delivery functions in association with the collections of services; and
providing access to said stored performance metrics to a third party to allow monitoring of the performance of at least one of said a service delivery functions for at least one of said collections of services.

20. A computer implemented method of allocating governance responsibilities in a multi-sourced technology based service environment, the method including the steps of:
defining a plurality of service delivery functions;
defining collections of services that are to be provided by several service providers, wherein said collections of services are associated with said service delivery functions;
defining a rules engine that includes resolution information for resolving an event associated with at least one of said collections of services;
receiving information associated with said event;
providing said event information to said rules engine;
processing said event information in said rules engine; and
outputting resolution information associated with said event from said rules engine.

21. The method of claim 20, wherein said resolution information includes at least one of information identifying an entity responsible for resolving said event and instructions for resolving said event.

22. A computer implemented method for defining the requisite roles, functions or responsibilities in a multi-sourced technology based service environment, the method including the steps of:
defining a governance model by defining an operational level of governance and at least one further level of governance for said model from the group consisting of: a tactical level of governance; a strategic level of governance;
defining said operational level of governance by:
defining a plurality of service delivery functions which include services and processes; and
defining collections of services provided by several service providers, wherein said collections of services are associated with said service delivery functions;
defining levels of governance by:
defining a plurality of roles for controlling the provision of said service delivery functions;
changing a process, service or role; and
adapting said governance model based on said changed process, service or role to ensure collaboration between said governance levels.

23. The method of claim 22 including the steps of:
changing a process or service; and
adapting said governance model by adapting any roles that are associated with said changed process or service.

24. The method of claim 22 including the steps of:
changing an existing role; and adapting said governance model by adapting any services or processes in said operational level of governance that are associated with said changed role.
